(19) United States
(12) Patent Application Publication
(10) Pub. No.: US 2018/0233054 A1
(43) Pub. Date: Aug. 16, 2018

(54) METHOD AND APPARATUS FOR CONTROLLING AGENT MOVEMENT IN AN OPERATING SPACE

(71) Applicant: Infinium Robotics Pte Ltd, Singapore (SG)

(72) Inventors: Junyang Woon, Singapore (SG); Jaime Rubio Hervas, Singapore (SG); Weihua Zhao, Singapore (SG); Soon Hooi Chiew, Singapore (SG); Zala Pogorelcnik, Singapore (SG); Richard Eka, Singapore (SG)

(21) Appl. No.: 15/516,454

(22) PCT Filed: Oct. 2, 2015
(86) PCT No.: PCT/SG2015/050365

§ 371 Date: Apr. 3, 2017

(30) Foreign Application Priority Data
Oct. 3, 2014 (SG) 10201406357Q
Jul. 27, 2015 (SG) 10201505848S

(51) Int. Cl. G08G 5/00; G08G 5/04

(52) U.S. Cl. CPC G08G 5/0069; G08G 5/0043; G08G 5/0013; G08G 5/045; G08G 5/006; G08G 5/0086; G08G 5/0034; G08G 5/0026; G08G 5/0082; G08G 5/0091; G08G 5/0056

(57) ABSTRACT

An apparatus and method for controlling agent movement in an operating space, the apparatus comprising: a processor; a communication interface; a storage device for storing one or more routines, the processor controls the apparatus to: process information about the operating space received by the communication interface to predict one or more interfering condition; divide the operating space into a plurality of sub-regions based on the predicted one or more interfering condition; define operating constraints for each agent in each sub-region having the predicted one or more interfering condition; and generate a movement path in the respective sub-region having the predicted one or more interfering condition for each agent in each sub-region having the predicted one or more interfering condition based on the defined operating constraints so as to avoid the predicted one or more interfering condition.

### FIELD OF THE INVENTION

The present invention relates to a method and apparatus for controlling agent movement in an operating space and, in particular, for navigation of agent flight paths in the operating space.

### BACKGROUND

Unmanned aerial vehicles (UAVs) have rapidly evolved over the past decade. This evolution has enhanced their potential to become a solution, not only for military, but for civilian applications. Nevertheless, enabling a sufficiently autonomous and safe environment is one of the main pending challenges when operating UAVs. Such concern has prevented regulatory authorities from fully enabling deployment of UAVs and integration of vehicles in the airspace.

Current efforts from individual parties (for example, regulatory authorities or researchers) include detection of conflicts (for example, UAV collisions) and resolution of conflicts based on aircraft to aircraft communication. However, such an approach has drawbacks as it limits the operation of conflicting vehicles to a definite number. If a large number of UAVs share the same airspace, the aforementioned methodologies may lead to dead-lock situations in which two or more UAVs are each waiting for the other to fly past, and thus neither ever does. Moreover, aircraft to aircraft conflict detection and conflict resolution increases the on-board computational requirements.

Examples can be found in U.S. Pat. No. 2013/0238170 A1, U.S. Pat. No. 7,737,878 B2, U.S. Pat. No. 8,463,464 B2, or U.S. Pat. No. 7,894,948 B2. Some of the proposed solutions are based on a reactive approach, i.e. a conflict needs to be detected when it is imminent to happen (for example, U.S. Pat. No. 2013/0080043 A1 or U.S. Pat. No. 2012/0158219 A1). Similarly, this solution limits the potential of an optimal use of the airspace, given that paths are not planned in an optimal way in advance, but just immediately before the conflict appears, which may translate in traffic congestions, quick battery consumption or other non-desirable consequences. Moreover, this approach is normally associated with a pair of two conflicting UAVs instead of a plurality of them; for instance, twenty, hundred or even thousand.

Based on current technological developments, predictive planning algorithms can be used to overcome the aforementioned situations. U.S. Pat. No. 6,498,968 B1 presents a predictive control strategy, which is forward-looking as opposed to merely reactive; however, not much interest is given to the implementation of such strategy in a real world application as it is much focused on the algorithms used rather than actual application. Furthermore, in actual application, huge computational issues are important practical problems that are not resolved in the above methods. Simple planning and avoidance algorithms have been found in the literature, for instance, U.S. Pat. No. 2013/0270394 A1 or U.S. Pat. No. 8,543,265 B2; these algorithms are not idoneous due to restriction in operating only a low amount of coordinated vehicles on the same operating space.

Another problem with existing technologies is that with limited airspace altitude that is expected to be released in the future for UAVs, existing technologies available to avoid conflicts will likely lead to dead-lock situations where large numbers of UAVs (for example, thousands) will be jammed in a confluence zone.

### SUMMARY

According to one aspect of an embodiment of the present invention, there is provided an apparatus for controlling agent movement in an operating space. The apparatus comprises:
a processor;
a communication interface configured for communicating with a plurality of ground control stations and/or a plurality of agents in the operating space to allow the apparatus to receive information about the operating space, each of the plurality of ground control stations being configured for controlling and monitoring a group of the plurality of agents,
a storage device for storing one or more routines which, when executed under control of the processor, control the apparatus to:
process information about the operating space received by the communication interface to predict one or more interfering condition in the operating space;
divide the operating space into a plurality of sub-regions based on the predicted one or more interfering condition;
define operating constraints for each of the one or more of the plurality of agents in each sub-region having the predicted one or more interfering condition; and
generate a movement path in the respective sub-region having the predicted one or more interfering condition for each of the one or more of the plurality of agents in each sub-region having the predicted one or more interfering condition based on the defined operating constraints so as to avoid the predicted one or more interfering condition,
wherein the communication interface is configured for transmitting data of the movement path to the plurality of ground control stations and/or the one or more of the plurality of agents in each sub-region having the predicted one or more interfering condition.

The processor may be configured for processing information about the operating space received by the communication interface from a plurality of relay stations in the operating space to predict the one or more interfering condition in each of the plurality of sub-regions.

Each of the plurality of relay stations may be associated with a sub-space in the operating space and may be configured for relaying information about the sub-space to the communication interface from one or more of the plurality of agents present in the sub-space or from one or more of the plurality of ground control stations or configured for obtaining information about the sub-space from one or more of the plurality of agents present in the sub-space or from one or more of the plurality of ground control stations, wherein each of the plurality of ground control stations is configured for controlling and monitoring a group of the plurality of agents and each of the plurality of ground control stations is configured for obtaining information about the operating space from the respective group of the plurality of agents.

The communication interface may be configured for communicating with a network enabled device other than the plurality of ground control stations and the plurality of agents for obtaining information of the operating space to be processed by the processor to predict the one or more interfering condition in each of the plurality of sub-regions.

The one or more routines may be executed continuously in real time during operation of the apparatus to process the information about the operating space to predict the one or more interfering condition and generate the movement path in the respective sub-region having the predicted one or more interfering condition for each of the one or more of the plurality of agents in each sub-region having the predicted one or more interfering condition to avoid the predicted one or more interfering condition.

Each of the plurality of agents may be an unmanned aerial vehicle.

Process information about the operating space received by the communication interface to predict one or more interfering condition in the operating space may include:
determine a zone surrounding each of the plurality of agents in the operating space;
determine whether the zones surrounding each of the plurality of agents intersect with each other; and
predict presence of the one or more interfering condition if the zones intersect with each other.

Process information about the operating space received by the communication interface to predict one or more interfering condition in the operating space may include:
determine a no-access zone in the operating space based on the information about the operating space received by the communication interface;
determine one or more reference points approximating a contour of the no-access zone;
determine whether a zone surrounding each of the plurality of agents intersects with the contour of the no-access zone; and
predict presence of the one or more interfering condition if the zone surrounding the plurality of agents intersects with the contour of the no-access zone.

Process information about the operating space received by the communication interface to predict one or more interfering condition in the operating space may include:
determine a value indicative of closest distance between two agents of the plurality of agents along pre-determined movement paths of the two agents in the operating space; and
predict presence of the one or more interfering condition by comparing the value with a threshold value.

The apparatus may be configured, under control of the processor to:
determine a monitoring zone in the operating space based on the information about the operating space received by the communication interface; and
monitor the monitoring zone to determine whether the monitoring zone has to be changed into an interfering condition.

Divide the operating space into a plurality of sub-regions based on the predicted one or more interfering condition may include:
divide the operating space into a plurality of cells, wherein each of the plurality of cells corresponds with a corresponding agent in the plurality of agents; and
merge a first set of cells to form a sub-region of the plurality of sub-regions if the predicted one or more interfering condition affect the corresponding agents in the first set of cells.

Divide the operating space into a plurality of sub-regions based on the predicted one or more interfering condition may further include:

merge a second set of cells to form a sub-region of the plurality of sub-regions if none of the predicted one or more interfering condition affect the corresponding agents in the second set of cells.

The apparatus may be configured, under control of the processor to:
analyze dynamics of each of the one or more of the plurality of agents in the sub-region having the predicted one or more interfering condition: and
define the operating constraints for each of the one or more of the plurality of agents in each sub-region having the predicted one or more interfering condition based on the analyzed dynamics.

The apparatus may be configured, under control of the processor to:
analyze structure of each of the one or more of the plurality of agents in each sub-region having the predicted one or more interfering condition; and
define the operating constraints for each of the one or more of the plurality of agents in each sub-region having the predicted one or more interfering condition based on the analyzed structure.

The apparatus may be configured, under control of the processor to:
analyze movement formation that each of the one or more of the plurality of agents in each sub-region having the predicted one or more interfering condition is configured to form; and
define the operating constraints for each of the one or more of the plurality of agents in each sub-region having the predicted one or more interfering condition based on the analyzed movement formation.

The apparatus may be configured, under control of the processor to:
analyze environmental conditions surrounding each of the one or more of the plurality of agents in each sub-region having the predicted one or more interfering condition; and
define the operating constraints for each of the one or more of the plurality of agents in each sub-region having the predicted one or more interfering condition based on the analyzed environmental conditions.

Generate the movement path in the respective sub-region for each of the one or more of the plurality of agents in each sub-region having the predicted one or more interfering condition may include generate a plurality of waypoints or a plurality of operating trajectories in the respective sub-region for the respective one of the plurality of agents in each sub-region having the predicted one or more interfering condition based on the defined operating constraints.

Generate the movement path in the respective sub-region for each of the one or more of the plurality of agents in each sub-region having the predicted one or more interfering condition may include formulate the movement path as a cost minimization function subject to the defined operating constraints.

The storage device may store a database of emergency gathering areas for one or more of the plurality of agents to navigate to one or more of the emergency gathering areas.

The storage device may store a database of power supply charging stations for the one or more of the plurality of agents to navigate to one or more of the power supply charging stations.

The apparatus may be configured, under control of the processor to:
divide the operating space into a plurality of sub-areas, wherein each of the plurality of sub-areas is assigned an indicator to indicate a degree of interference and the degree of interference depends on number of the plurality of agents in the respective sub-area.

The apparatus may be configured, under control of the processor to:
generate an initial movement path for each of the plurality of agents in the operating space before departure of the respective agent based on the assigned indicators of the plurality of sub-areas so as to avoid the predicted one or more interfering condition.

The communication interface may be configured to transmit one or more of the following to the plurality of ground control stations and/or the plurality of agents:
operating space restrictions to the plurality of agents in the operating space;
weather update and forecast in the operating space;
location of one or more agents adjacent to one of the plurality of agents;
location of obstructing terrain that contributes to the one or more interfering condition; and
location of man-made object that contributes to the one or more interfering condition.

According to another aspect of an embodiment of the present invention, there is provided a method for controlling agent movement in an operating space, the method comprising:
communicating with a plurality of ground control stations and/or a plurality of agents in the operating space to receive information about the operating space;
processing information about the operating space to predict one or more interfering condition in the operating space;
dividing the operating space into a plurality of sub-regions based on the predicted one or more interfering condition;
defining operating constraints for each of the one or more of the plurality of agents in each sub-region having the predicted one or more interfering condition; and
generating a movement path in the respective sub-region having the predicted one or more interfering condition for each of the one or more of the plurality of agents in each sub-region having the predicted one or more interfering condition based on the defined operating constraints so as to avoid the predicted one or more interfering condition; and
transmitting data of the movement path to the plurality of ground control stations and/or the one or more of plurality of agents in each sub-region having the predicted one or more interfering condition.

According to yet another aspect of an embodiment of the present invention, there is provided a system for controlling agent movement in the operating space, the system comprises:
a plurality of agents;
a plurality of ground control stations; wherein each of the plurality of ground control stations is configured for controlling and monitoring a group of the plurality of agents and each of the plurality of ground control stations is configured for obtaining information about the operating space from the respective group of the plurality of agents;
and
at least one of the apparatus for controlling agent movement in the operating space.

The system may comprise a plurality of relay stations, wherein each of the plurality of relay stations is associated with a sub-space in the operating space and is configured for relaying information about the sub-space to the communication interface from one or more of the plurality of agents present in the sub-space or from one or more of the plurality of ground control stations or configured for obtaining information about the sub-space from one or more of the plurality of agents present in the sub-space or from one or more of the plurality of ground control stations.

### BRIEF DESCRIPTION OF THE DRAWINGS

In order that embodiments of the invention may be fully and more clearly understood by way of non-limitative examples, the following description is taken in conjunction with the accompany drawings in which like reference numerals designate similar or corresponding elements, regions and portions, and in which:

FIG. 1 is a diagram illustrating an exemplary system for controlling agent movement in an operating space;

FIG. 1A is a block diagram illustrating components of an Agent Traffic Management System (ATMS);

FIG. 1B shows an example of the components of a processor of the ATMS;

FIG. 2 is a diagram illustrating an exemplary communication network system between different parties in the operating space;

FIG. 3 is a process flow diagram illustrating a method of receiving data of a movement path from the ATMS by a user of an agent;

FIG. 4 is a diagram illustrating the presence of a conflicting area in the movement path of the agent;

FIG. 5 is a process flow diagram illustrating the tasks performed by the ATMS in the operating space;

FIG. 6 is a diagram illustrating one or more interfering condition in the operating space to movement of the agent;

FIG. 7 is a process flow diagram illustrating a logical evaluation of weather interfering condition;

FIG. 8 is a process flow diagram illustrating an interfering condition such as a wind condition;

FIG. 9 is a diagram illustrating a recommendation of movement paths to a plurality of agents by the ATMS based on the wind interfering condition;

FIG. 10 is a diagram illustrating air traffic condition in the operating space at time tₖ;

FIG. 11 is a diagram illustrating air traffic condition in the operating space at time (tₖ+T);

FIG. 12 is a diagram illustrating air traffic condition in the operating space at time (tₖ+2T);

FIG. 13 is a diagram illustrating air traffic condition in the operating space at time (tₖ+3T);

FIG. 14 is a diagram illustrating a recommendation of an initial movement path by the ATMS to an agent;

FIG. 15 is a process flow diagram illustrating a method adopted by the ATMS;

FIG. 16 is a diagram illustrating an example of using a Flexible Spatial Region Divider (FSRD) module to reduce computational data for processing at time tₖ;

FIG. 16A is a diagram illustrating different shapes of a zone defined to surround an agent;

FIG. 17 is a diagram illustrating an example of using a Flexible Spatial Region Divider (FSRD) module to reduce computational data for processing at time tₖ+T;

FIG. 18 is a Voronoi diagram illustrative of generation of sub-regions from an operating space by the FSRD module;

FIG. 19 is a Voronoi diagram illustrating division of the operating space into different Voronoi cells;

FIG. 20 is a Voronoi diagram illustrating presence of interfering conditions in the respective Voronoi cells;

FIG. 21 is a Voronoi diagram illustrating re-division of the Voronoi cells in FIG. 20 due to the presence of interfering conditions;

FIG. 21A is a diagram illustrating prediction of an interfering condition between agents;

FIG. 21B illustrates overcoming a limitation of Voronoi diagrams;

FIG. 21C is a diagram illustrating prediction of an interfering condition between agents;

FIG. 21D illustrates a Closest Point of Approach method;

FIG. 22 is a process flow diagram illustrating a FSRD algorithm that uses one way to predict interfering condition;

FIG. 22A is a process flow diagram illustrating a FSRD algorithm that uses another way to predict interfering condition;

FIG. 23 is a graphical illustration of forward and backwards reachable sets and safe envelope;

FIG. 24 is a flow chart illustrating a method for determining states constraints;

FIG. 25 is a diagram illustrating generation of waypoints by using a Motion Predictive Control (MPC) module;

FIG. 26 is a flow chart illustrating different algorithms used by the ATMS to generate recommended actions for agents;

FIG. 27 is a diagram illustrating providing a recommended action by the ATMS to one or more agents to resolve conflict in an operating space;

FIG. 28 is a diagram illustrating prediction of a conflict for a plurality of agents at time t_{K};

FIG. 29 is a diagram illustrating changing of navigation courses by some of the plurality of agents in FIG. 28 to avoid conflict at time (t_{K}+Δt);

FIG. 30 is a diagram illustrating changing of navigation courses by the plurality of agents in FIG. 29 to avoid conflict at time (t_{K}+2Δt);

FIG. 31 is a diagram illustrating that the conflict has been resolved and the plurality of agents in FIG. 30 have resumed to their initial speeds at time (t_{K}+3Δt);

FIG. 32 is a diagram illustrating a tubular corridor in an operating space extending from one location to another location;

FIG. 33 is a diagram illustrating integration of the ATMS with existing systems.

### DESCRIPTION

While exemplary embodiments pertaining to the invention have been described and illustrated, it will be understood by those skilled in the technology concerned that many variations or modifications involving particular design, implementation or construction are possible and may be made without deviating from the inventive concepts described herein.

### 1. System Infrastructure

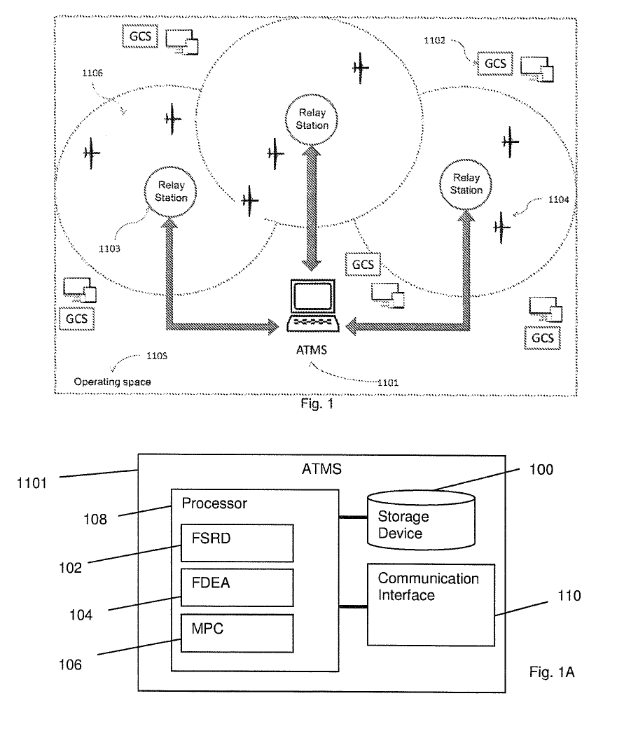

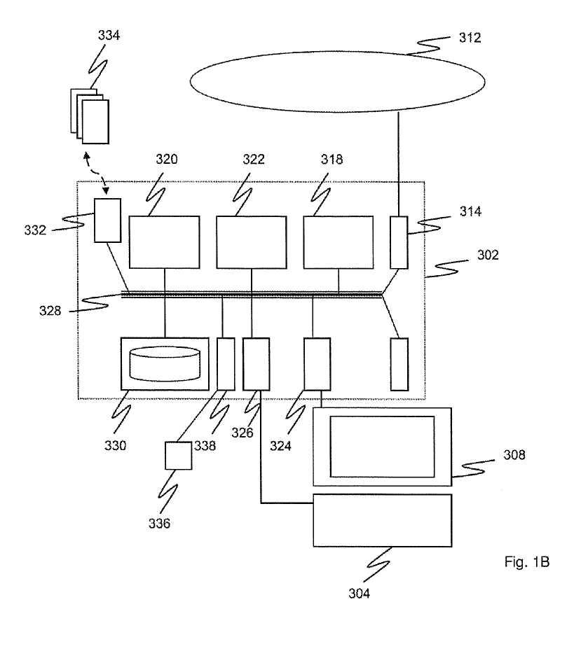

FIG. 1 illustrates an exemplary system 1000 for controlling agent movement in an operating space 1105. The system 1000 comprises a plurality of agents 1104; a plurality of ground control stations (GCS) 1102, wherein each of the plurality of ground control stations 1102 is configured for controlling and monitoring a group of the plurality of agents 1104 and each of the plurality of ground control stations 1102 is configured for obtaining information about the operating space 1105 from the respective group of the plurality of agents 1104; and at least one apparatus (refers to reference numeral 1101). The system 1000 may further comprise a plurality of relay stations 1103, wherein each of the plurality of relay stations 1103 is associated with a sub-space 1106 in the operating space 1105 and is configured for obtaining information about the sub-space 1106 from one or more of the plurality of agents 1104 present in the sub-space 1106 or from one or more of the plurality of ground control stations 1102. The plurality of relay stations 1103 is an optional component of the system 1000.

The components of the at least one of the apparatus 1101 are illustrated in FIG. 1A. The at least one of the apparatus 1101 comprises a processor 108; a communication interface 110 configured for communicating with the plurality of ground control stations 1102 and/or the plurality of agents 1104 in the operating space 1105 to allow the apparatus 1101 to receive information about the operating space 1105 and a storage device 100 for storing one or more routines. An example of each of the at least one of the apparatus 1101 is in the form of a centralized computer-based Agent Traffic Management Systems (ATMS) 1101 as described herein, which coordinates the operating space 1105 and the plurality of agents 1104 within the operating space 1105 in real-time and in an optimal way.

In the present disclosure, the ATMS will be known by several reference numerals in the description and the drawings, namely, 1101, 1204, 1302, 1305, 1502, 1601, 1702, 1804, 1903, 2605, 3106, 3702, 3704 and 3706. Furthermore, an ATMS described without reference numeral in the description is the same as each of the ATMS with the aforementioned reference numerals. It is appreciated that the features and functions of all the ATMS described will be the same despite different reference numerals or without reference numeral.

The main task of the ATMS 1101 is to coordinate the movements of the plurality of agents 1104 within the operating space 1105 in real-time, in an optimal way and free of collisions. The ATMS 1101 may also account for a series of limitations, such as restrictions in the operating space 1105, weather constraints, presence of obstacles and physical capabilities of the plurality of agents 1104.

Other than communicating with the plurality of ground control stations 1102 and/or the plurality of agents 1104 in the operating space 1105, the communication interface 110 is also configured for communicating with the plurality of relay stations 1103, users of the plurality of agents 1104, or other relevant parties (for example, Civil Aviation Authorities, meteorological stations, and similar governmental, private or corporate parties). The ATMS 1101 records information about the operating space 1105 and plurality of the agents' 1104 movement paths (i.e. trajectories) and operations, which may be stored in the storage device 100. The ATMS 1101 shall be protected against fail-safe, for instance, through duplication or back-up on another server, but not limited to them. Under some circumstances (for example, for operational reasons related to regulatory authorities requests), additional ATMS 1101 may be used.

The task of the plurality of relay stations 1103 is to allow real-time tracking and/or communication with the plurality of agents 1104 in the respective sub-spaces 1106 and/or with their associated plurality of the GCS 1102. The plurality of relay stations 1103 may carry out some low-level tasks, such as information gathering from the plurality of agents 1104 and pre-processing of data, but not limited to these tasks. For example, the plurality of relay stations 1103 may compile real-time updates of the plurality of agents' 1104 position, altitude, navigation course, speed and time stamp, as well as energy levels (for example, battery level or fuel consumption) or obstacle detections and elaborate a common information packet containing all the aforementioned data of all the plurality of agents 1104 in the respective sub-spaces 1106.

The ATMS 1101 communicates with the plurality of relay stations 1103 in the operating space 1105 to retrieve information about the operating space 1105 and subsequently elaborates a series of recommendations, which are shared with the users of plurality of agents 1104 through their respective plurality of GCS 1102. The recommendations shared may include suggested modifications in current flight plans such as altitude, navigation course, speed changes or suggested waypoints, but not limited to them. The plurality of relay stations 1103 may also be equipped with sensing capabilities of their environment (for example, weather), as well as sensing of the plurality of agents 1104 and obstacles in the region (for example, using radar, Ultra Wide Band—UWB—positioning systems, satellite data).

The processor 108 of the ATMS 1101 as illustrated in FIG. 1A is configured to include and operate a Flexible Spatial Region Divider (FSRD) module 102, a Full Dynamics Envelope Analysis (FDEA) module 104 and a Model Predictive Control (MPC) module 106.

The FSRD module 102 may be one or more routines stored in the storage device 100. The storage device 100 may be a non-transitory computer recordable medium. The one or more routines of the FSRD module 102 may, when executed under control of the processor 108, process information about the operating space 1105 received by the communication interface 110 to predict one or more interfering condition in the operating space 1105 and divide the operating space 1105 into a plurality of sub-regions based on the predicted one or more interfering condition. By dividing the operating space 1105 into the plurality of sub-regions, the number of agents 1104 that are considered for calculations by a path generator or a navigation system (for example, the MPC module 106 described later) to generate re-routing paths to avoid the predicted one or more interfering condition may be reduced, since only agents 1104 in each sub-region having the predicted one or more interfering condition are considered for such calculations, hence reducing computational time. The FSRD method may be used to convert a computationally-heavy multi-agents coordination problem into a computationally-feasible one and can be employed in the optimization process to intelligently divide the multiple agents' operation space 1105 into smaller sub-regions, which enables the optimization process to be feasible and real-time.

The terms “conflict” and “interfering condition” may be used interchangeably in the present disclosure.

The FDEA module 104 may be one or more routines stored in the storage device 100. The one or more routines of the FDEA module 104 may when executed under control of the processor 108, define operating constraints for each of the one or more of the plurality of agents in each sub-region having the predicted one or more interfering condition. FDEA aims to prevent loss of control of the one or more of the plurality of agents 1104 in each sub-region having the predicted one or more interfering condition by defining operating constraints so that the one or more of the plurality of agents in each sub-region having the predicted one or more interfering condition are not required to perform maneuvers beyond their limits.

The MPC module 106 may be one or more routines stored in the storage device 100. The one or more routines of the MPC module 106 may when executed under control of the processor 108, generate a movement path in the respective sub-region having the predicted one or more interfering condition for each of the one or more of the plurality of agents 1104 in each sub-region having the predicted one or more interfering condition based on the defined operating constraints so as to avoid the predicted one or more interfering condition.

The communication interface 110 is configured for transmitting data of the movement path to the plurality of ground control stations 1102 and/or the ones of the plurality of agents 1104 in each sub-region having the predicted one or more interfering condition and/or the plurality of relay stations 1103. The process of the MPC module 106 is formulated as an optimization problem (i.e. minimization of a cost function) subject to the system dynamics and constraints.

Notably, in the present example, only agents in sub-regions presenting interfering conditions that are filtered in the FSRD method will be evaluated by the FDEA module 104. The MPC module 106 will take into account operating constraints generated by the FDEA module 104 and, subsequently, will generate conflict-free paths in an optimal way subject to the operating constraints.

FIG. 1B shows in detail an example of the processor 108 in FIG. 1A having the FSRD module 104, FDEA module 104 and MPC module 105 that is configured for the following respective tasks:
processing information about the operating space 1105 received by the communication interface 110 to predict one or more interfering condition in the operating space 1105;
dividing the operating space 1105 into a plurality of sub-regions based on the predicted one or more interfering condition;
defining operating constraints for each of the one or more of the plurality of agents 1104 in each sub-region having the predicted one or more interfering condition; and
generating a movement path in the respective sub-region having the predicted one or more interfering condition for each of the one or more of the plurality of agents 1104 in each sub-region having the predicted one or more interfering condition based on the defined operating constraints so as to avoid the predicted one or more interfering condition.

The processor 108 may include user input modules such as a computer mouse 336, keyboard/keypad 304, and/or a plurality of output devices such as a display 308. The display 308 may be a touch screen capable of receiving user input as well.

The processor 108 may be connected to a computer network 312 via a suitable transceiver device 314 (i.e. a network interface), to enable access to for example, the Internet or other network systems such as a wired Local Area Network (LAN) or Wide Area Network (WAN). Optionally, the processor 108 may be connected to one or more external wireless communication enabled devices 334 via a suitable wireless transceiver device 332 for example, a WiFi transceiver, Bluetooth module, Mobile telecommunication transceiver suitable for Global System for Mobile Communication (GSM), 3G, 3.5G, 4G telecommunication systems, and the like. Through the computer network 312, the processor 108 can gain access to one or more storages i.e. data storages (for example, the storage device 100 in FIG. 1A), databases, data servers and the like connectable to the computer network 312 to retrieve and/or store data in the one or more storages. The communication interface 110 in FIG. 1A can be the transceiver device 314, and/or the one or more external wireless communication enabled devices 334, which enables the processor 108 (i.e. representative of the core of the ATMS 1101) to communicate with the plurality of GCS 1102 and/or each of the plurality of agents 1104 in each sub-region having the predicted one or more interfering condition and/or the plurality of relay stations 1103.

The processor 108 may include a processor integrated circuit 318, a Random Access Memory (RAM) 320 and a Read Only Memory (ROM) 322. The storage device 100 in FIG. 1A may also be one of the RAM 320 or the ROM 322. The processor 108 may also include a number of Input/Output (I/O) interfaces, for example, I/O interface 338 to the computer mouse 336, a memory card, flash memory, a solid state drive or a hard disk drive 316, I/O interface 324 to the display 308, and I/O interface 326 to the keyboard/keypad 304.

The components of the processor 108 typically communicate via an interconnected bus 328 and in a manner known to the person skilled in the relevant art.

An “agent” in the present disclosure may for example, refer to each of the agents in the plurality of agents 1104 and can be described as a manned vehicle or an autonomous object which may include, but not limited to, robots, unmanned aerial, marine or ground vehicles. Furthermore, the term “agent” can indicate a ground-based, water-based, air-based, or outer space-based (in short “space-based”) vehicle that is capable of carrying out one or more trajectories and capable of following positional commands given by actuators. Here, “aircraft” may be used to describe a vehicle with a particular characteristic of agent motion, such as “flight.” In general, “aircraft” and “flight” are terms representative of an agent, and agent motion, respectively although specific types of agents and corresponding motion may be substituted therefore, including ground-, marine- or space-based agents. Operating space refers to the space (for example, water, land, outer space or air) in which the agents develop or carry out their activities. In many examples described herein, for convenience, the plurality of agents 1104 would refer to airborne agents and the operating space is the airspace.

Users are referred herein as those operating the plurality of agents 1104, typically through the plurality of GCS 1102. For convenience, the reference numeral 1104 is applicable to the plurality of agents as well as to each of the plurality of agents as well. For example, a physical person may wish to operate an agent 1104 in the previously described operating space 1105. The agent 1104 may include an Unmanned Aerial Vehicle (UAV) or a piloted aircraft, both at a commercial and/or consumer level. The user is able to upload his/her intentions to the ATMS 1101. For example, he/she can upload a flight plan to the ATMS 1101, which could be defined by a series of waypoints to be flown by an agent belonging to the user. Additional information may be included such as associated time (for example, take off time), optimality criteria (for example, minimum flight time or minimum battery consumption) or mission to be fulfilled that may include real-time defined trajectories according to specific requirements, for example, tracking of a target or transporting an object from one place to another. A user of the agent may upload capabilities of his/her agent 1104 or plurality of agents 1104 such as, for instance, the type of agent 1104 (for example, model and manufacture year, and weight), agent's 1104 performance capabilities (for example, maximum velocity and acceleration), agent's 1104 disturbance resistance (for example, wind resistance), range or endurance, but not limited to them. Range is defined as distance the agent 1104 can travel, whereas endurance refers to the maximum length of time that the agent 1104 can spend in flight. All these inputs of information may be updated in real-time during the agent 1104 operation, either by agent's 1104 monitoring carried out by the ATMS 1101, optionally by the ATMS's connected network of plurality of relay stations 1103, or the plurality of GCS 1102, or directly by the user (for example, user may request a flight plan modification or alert of an operational failure in his/her agent 1104). Recommendations from the ATMS 1101 are communicated in real-time to users who are free to choose whether to perform trajectory modifications of their respective plurality of agents 1104 based on the recommendations. As an alternative to just receiving recommendations, users have the freedom to configure the ATMS 1101 to directly perform trajectory modifications of the plurality of agents 1104. Such configuration of the ATMS 1101 may include enabling compatible systems, for example, by being compatible with any MAVLink Micro Air Vehicle Communication Protocol autopilot.

The users may operate one or more of the plurality of agents 1104 through one or more of the plurality of GCS 1102 and make use of the one or more plurality of GCS 1102 to communicate with the ATMS 1101 and/or communicate with the one or more of the plurality of agents 1104. The plurality of GCS 1102 may use software, which standardizes the integration of the plurality of agents 1104 into the present described system 1000. The plurality of GCS 1102 may also enable some low-level tasks such as information gathering from the plurality of agents 1104 and pre-processing of data. For example, the plurality of GCS 1102 may compile real-time updates of the plurality of agents' 1104 position, altitude, navigation course, speed or time stamp as well as energy level or obstacle detection and elaborate a common information packet containing all the aforementioned data to be shared with the ATMS 1101. The ATMS 1101 then communicates with the plurality of GCS 1102 to retrieve such information and further process the information to analyze potential conflicts (also known herein as interfering conditions) and subsequently elaborate a series of navigation recommendations (for example, the movement path generated by the MPC module 106), which are sent back to the corresponding plurality of GCS 1102 in the network. Sent information may include suggested modifications in their current flight plans such as altitude change, navigation course change, speed changes or suggested waypoints, which are related to a movement path, but not limited to them. The plurality of GCS 1102 may include a processor (not shown in Figures but similar to the processor 108 of the ATMS 1101), a storage device (not shown in Figures but similar to the storage device 100 of the ATMS 1101), a communication interface (not shown in Figures but similar to the communication interface 110 of the ATMS 1101) for communicating with the plurality of agents 1104 and the ATMS 1101 (either directly or through the plurality of relay stations 1103), and a telemetry module (not shown in Figures). Details of the telemetry module will be described in section “2. Communications” below. It is appreciated that the ATMS 1101 may also comprise a telemetry module.

### 2. Communications

FIG. 2 illustrates an exemplary communication network system between different parties in the operating space 1105 in FIG. 1 that can be implemented in the system 1000 in FIG. 1. A plurality of relay stations 1207 (for simplicity, only one relay station is shown in FIG. 2) has the ability to communicate with an ATMS 1204 in a number of different ways. For example, wired or wireless communication can be used such as fiber-optic communication or co-axial cable, Ethernet, GSM networks or radio frequency based systems. In the present example, each of the plurality of relay stations 1207 is associated with a sub-space of the operating space 1105 in FIG. 1.

The plurality of relay stations 1207 may each be equipped with a communication interface (not shown in Figures but similar to the communication interface 110 of the ATMS 1101) for communicating with one or more of a plurality of agents 1201 (for simplicity, only one agent is shown in FIG. 2) in the sub-space associated with the respective relay station. Also, each of the plurality of relay stations 1207 may include a telemetry module (not shown in Figures). The telemetry module may include, as an example, XBee DigiMesh 2.4 RF Module or a Lairdtech LT2510 RF Module. Additionally, the plurality of relay stations 1207 may use radio communications or GSM networks to communicate.

Communication messages sent between the plurality of agents 1201 and the plurality of relay stations 1207 can be encoded and decoded according to common protocols, for example, a MAVLink Micro Air Vehicle Communication Protocol (MAVLink protocol) or commonly used internet protocols (Transmission Control Protocol or TCP and User Datagram Protocol or UDP).

Similarly, each of a plurality of ground control stations (GCS) 1202 (For simplicity, only one GCS is shown in FIG. 2) may communicate with the ATMS 1204 in a number of different ways with the currently available technology. For example, each of the plurality of GCS 1202 may use wired technologies such as Ethernet. Each of the plurality of GCS 1202 may also use wireless technologies such as GSM networks, which may motivate the use of personal computers, tablets, mobile phones or any similar devices via software programs, graphical interfaces or mobile applications to provide ease and dynamism to the end user. Each of the plurality of GCS 1202 may also use radio communications. User interface software could be designed and provided by the ATMS 1204 to users for installation in the respective plurality of agents 1201 controlled by the users and/or in each of the plurality of GCS 1202 used by the users. The user interface software may be supported by multiple OS platforms, for example, for Windows, Linux and Mac OS, but not limited to them. For example, an existing Open Source Ground Control Stations/Operator Control Unit such as QGroundControl (qgroundcontrol.org) could be easily adopted and further developed to fit the application. The interface software may integrate all the communication protocols to enable a standardized way of communicating with the ATMS 1204 and the respective plurality of agents 1201 as well as standardized ways of information sharing (for example, universal information packet about the plurality of agents' 1201 position, altitude, navigation course, speed, performance capabilities, etc).

Each GCS 1202 is associated with a group of the plurality of agents 1201. The plurality of GCS 1202 may each have a communication interface (similar to communication interface 110 in FIG. 1) for communicating with its associated group of the plurality of agents 1201 deployed in different locations of the operating space 1105. Also, each of the plurality of GCS 1202 includes a telemetry module similar to that described earlier. Similarly, the telemetry module may include, for example, XBee DigiMesh 2.4 RF Module or a Lairdtech LT2510 RF Module. Each of the plurality of GCS 1202 may use common radio communications or GSM networks. Communication messages sent between the plurality of agents 1201 and the plurality of GCS 1202 can be encoded and decoded according to commonly used protocols, for example, a MAVLink Micro Air Vehicle Communication Protocol (MAVLink protocol) or internet protocols (Transmission Control Protocol or TCP and User Datagram Protocol or UDP).

In an example, a user is flying an agent 1201 using a GCS 1202 (for example, his/her smartphone). A two-way communication 1203 may exist between the parties to obtain real-time information from the agent 1201 and send necessary commands from the GCS 1202. The GCS 1202 may be connected to the ATMS 1204 through a GSM network 1205 in such manlier that they may share available information, such as user's preferred navigation intention or trajectory suggestions (for example, the movement path generated by the MPC module 106 in FIG. 1A) of the ATMS 1204. The agent 1201 may broadcast data 1206 to a relay station 1207 that is associated with the sub-space where the agent 1201 is located. Fiber optic 1208 may be used to share this particular information between the relay station 1207 and the ATMS 1204. The ATMS 1204 may also communicate through a network enabled device 1209 with different relevant parties 1210 such as Civil Aviation Authorities and weather stations. A network enabled device 1209 may refer to a computer server, a smartphone, a portable computer and any other device enabled to communicate through a network such as the Internet. The network enabled device 1209 is controllable by the different relevant parties 1210.

### 3. Methodology

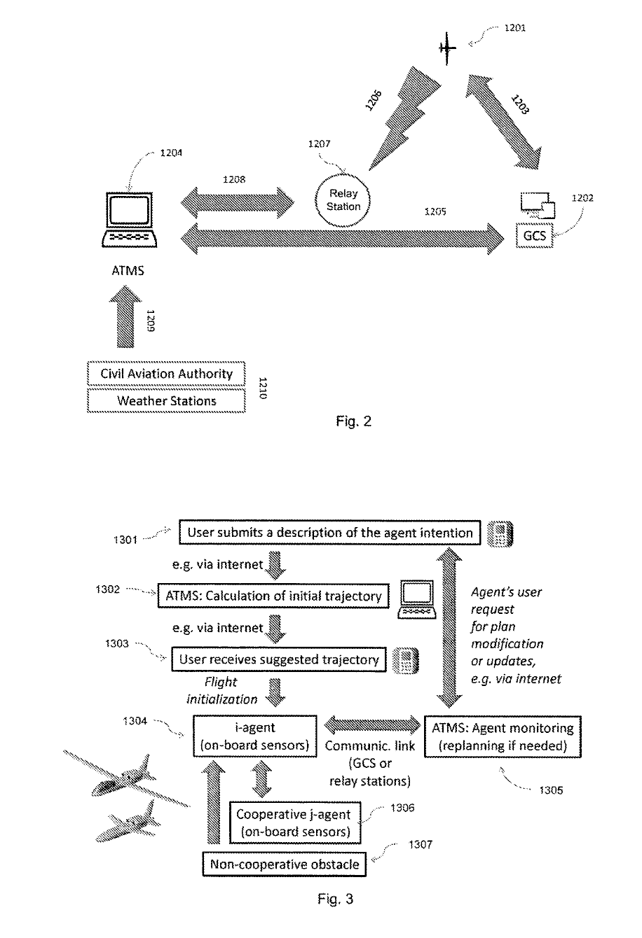

FIG. 3 illustrates a method of user interaction with an ATMS (for example, 1101 in FIG. 1) for example, through a Ground Control Station (GCS), which in this case is the user's smartphone. The method comprises the following steps.

At step 1301, an ATMS receives a description of an agent's user-preferred trajectory for example, from the user's smartphone using GSM networks. The agent's user-preferred trajectory may be expressed in a number of different ways, for example, as a set of waypoints or operating trajectory, as a pair destination/origin, or as a mission to be fulfilled. The mission may include real-time defined trajectories according to specific requirements, for example, tracking of a target, surveying an area, “follow me” modes and the like. The user may include additional information such as agent's user information (for example, agent's user personal/business profile and contact), the type of agent (for example, agent model and year of manufacture), performance capabilities (for example, maximum speed and acceleration), disturbance resistance (for example, wind resistance), range and/or endurance.

Standardized datasheets or forms may be provided by the ATMS to compile the aforementioned information, for example, these datasheets or forms may be submitted to the ATMS via mobile applications on smartphones. The agent and the agent's user may be defined by an identifier within the ATMS.

At step 1302, the method includes the ATMS processing the received agent's user-preferred trajectory together with one or more interfering condition (if any), for instance, obtained by the ATMS 1101 in FIG. 1 to obtain a recommended initial trajectory (i.e. initial movement path). The one or more interfering condition may include operating space restrictions, weather constraints, movement paths of other agents in the area that may affect the path of the user's agent, presence of obstacles that may affect the path of the user's agent and/or health or limitations of the user's agent that may affect its traveling or how it travels. It is noted that some of the one or more interfering condition is predicted by the ATMS after obtaining information from a plurality of GCS (for example, 1102 in FIG. 1) and/or a plurality of agents (for example, 1104 in FIG. 1) and/or a plurality of relay stations (for example, 1103 in FIG. 1) and/or from a network enabled device (for example, 1209 in FIG. 2).

All the algorithms and methods used by the ATMS to process data received, conduct initial trajectory planning and conduct re-planning of trajectories, generate trajectory recommendations for re-planning and the like will be described later in Section “4. Planning Algorithms”.

At step 1303, the recommended initial trajectory is sent to the user's smartphone i.e. the GCS from the ATMS for the user's consideration. By recommending this particular initial trajectory, the ATMS may have, in the process, predicted some potential conflicts (i.e. predicted one or more interfering condition) that may occur during the operational path of the agent.

The method then initializes the agent operations, i.e. flight initialization commences, in which the user's agent initiates its operation (for example, aircraft takes off). This can be done by a signal sent from the user's smartphone to the agent. The signal may include the recommended initial trajectory that the agent should proceed provided by the ATMS if the user agrees to the trajectory.

At step 1305, some of the potential conflicts may be solved during “trajectory re-planning” (refers to section “4.2 Re-planning” described later) by the ATMS after initiation of operation of the agent. For instance, some of the conflicts may not be recommended to be solved immediately and the resolution should be delayed until the conflict is closer to happen, given the dynamic character of the operating space.

After the initialization, every i-agent 1304 (refers to one of the user's agents) is, either continuously or at intervals, monitored by the ATMS at step 1305 via direct communication link with the agent 1304, the user's smartphone and/or one of a plurality of relay stations (for example, 1103 in FIG. 1).

If a conflict is detected either by the i-agent 1304 or the ATMS, for example, the presence of a non-cooperative obstacle 1307 or presence of another j-agent 1306 that may potentially interfere with the i-agent 1304, the ATMS may calculate collision-free trajectory or trajectories for the agents directly involved in the potential conflict. Alternatively, if the user requests a modification of the agent's current trajectory to the ATMS, the request is sent to the ATMS through the user's smartphone, which will calculate a new collision-free trajectory and the new collision-free trajectory is then suggested to the user (i.e. sent to the user's smartphone).

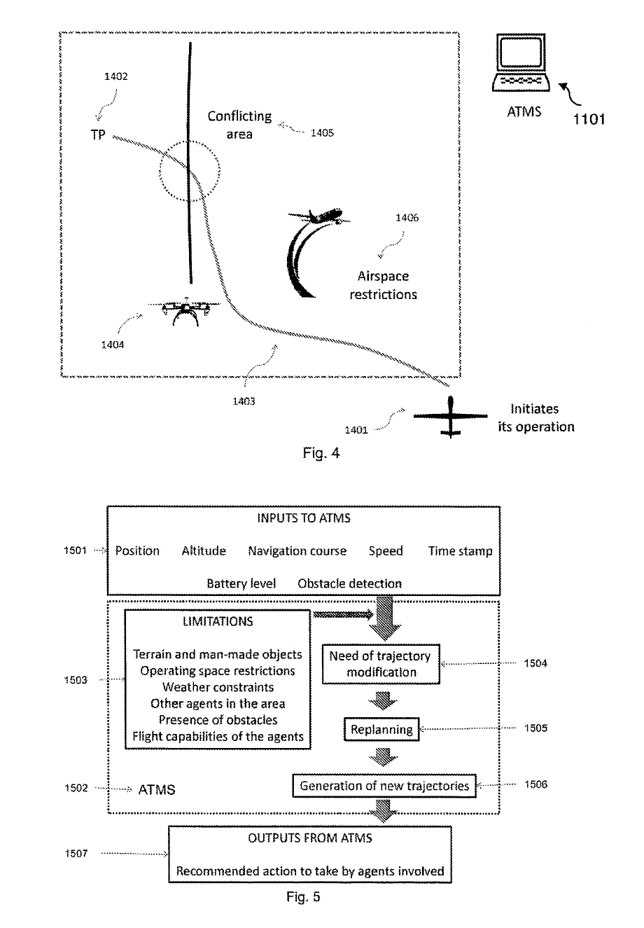

FIG. 4 illustrates the presence of a conflicting area 1405 in a movement path of an agent 1401. For example, an agent 1401 is initiating operation to reach a target point (TP) 1402. At this initial stage, an ATMS 1101 first suggests a simple trajectory 1403 to the agent 1401 for reaching TP 1402, which includes defined limitations, such as static obstacles to avoid (for example, terrain and man-made objects), weather constraints, operating space (for example, airspace) restrictions 1406 indicative of areas to avoid, heavy traffic and the like. However, at this initial stage, the ATMS 1101 does not recommend actions for limitations related to potential dynamic conflicts in a longer time-stamp (i.e. longer time period), such as a potential collision with another agent 1404 in the conflicting area 1405, which may happen after a certain time period. The reason lies in the fact that dynamic obstacles may rapidly change and might not exist in the future. For example, the agent 1404 may encounter head wind on its journey, which may delay its expected arrival time to the conflicting area 1405. Therefore, the ATMS 1101 can intelligently generate simple trajectories at the start of the operation of the agent 1404, without adding complexity to the system. If the conflict is still present in the future time-stamp (i.e. future time period), the ATMS 1101 will carry out what is known herein as re-planning to resolve the conflict using a method explained in Section “4.2 Re-planning” of “4. Planning Algorithm”.

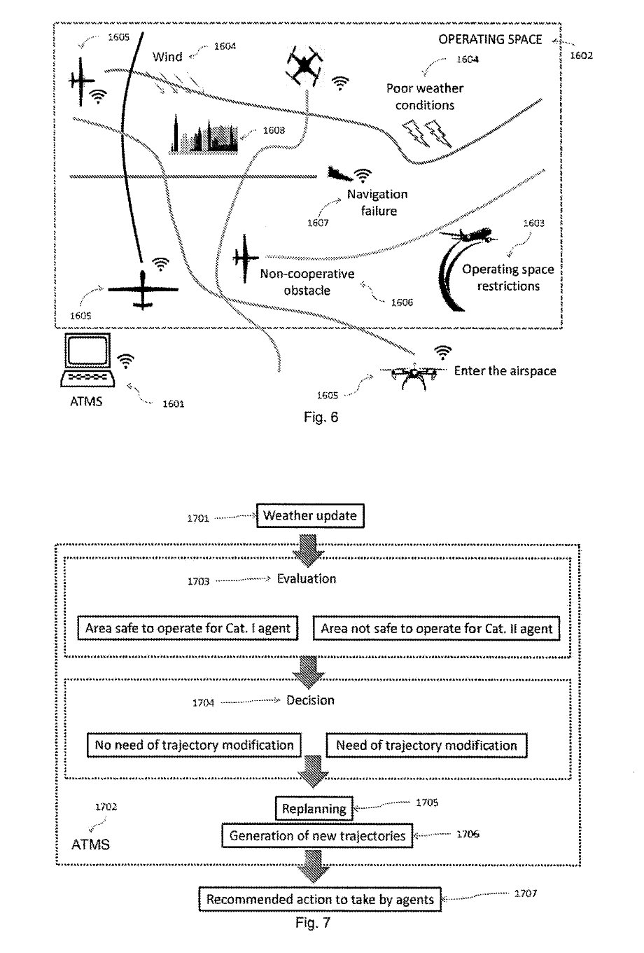

FIG. 5 illustrates tasks performed by an ATMS 1502 in an operating space and FIG. 6 illustrates one or more interfering conditions in the operating space that may interfere with movement of a plurality of agents. With reference to FIG. 5 and FIG. 6, in an example, each independent agent may share real-time information 1501 with the ATMS 1502 such as its position, altitude, navigation course, speed and time stamp (i.e. time of transmission of data of the real-time information), together with additional information such as energy level or obstacles detected in its area of reach.

Specific agents that are able to sense their environment may report findings to the ATMS and this provides additional obstacle detection capabilities to the system (for example, 1000 in FIG. 1) having the ATMS. For example, an agent may detect objects in its vicinity, which were not previously identified by the ATMS 1502 because none of the information sources (for example, the plurality of Ground Control Station (GCS) 1102 in FIG. 1 and/or the plurality of agents 1104 in FIG. 1 and/or the plurality of relay stations 1103 in FIG. 1 and/or the network enabled device 1209 in FIG. 2) providing information to the ATMS 1502 detected the objects. The specific agents may also detect non-cooperative agents or constraining weather conditions.

Users may report agent failures, contingencies or performance limitations. All the above-mentioned information can be shared with the ATMS 1502 by the cooperating agents and users (via the user's GCS), and incorporated into the entire system (for example, 1000 in FIG. 1) to alert (if necessary) the rest of agents connected to the system's network, making the system more robust and adding an additional layer of safety to the overall system.

The system or system's network described in the present disclosure may, for example, include the plurality of Ground Control Station (GCS) 1102 in FIG. 1 and/or the plurality of agents 1104 in FIG. 1 and/or the plurality of relay stations 1103 in FIG. 1 and/or at least one ATMS.

The ATMS 1502 may process all the aforementioned information together with potential limitations 1503. Such potential limitations 1503 include operating space restrictions 1603, weather constraints 1604, other agents in the area 1605, presence of obstacles 1606, performance or health of the agents 1607, or terrain and man-made objects 1608 that may interfere with movement paths of one or more agents. Obtaining such limitations may be integrated into the system and they can be obtained from a variety of available sources. The ATMS 1502 receives such limitations for processing. For example, Civil Aviation Authorities can set a series of operating space restrictions and provide real-time updates to the system. Weather information can be compiled from meteorological stations distributed across the operating space 1602 or from agents equipped with meteorological sensors, which share their information throughout the system. Terrain and man-made objects databases may be a-priori stored in a storage device (for example, 100 in FIG. 1A) of the ATMS 1502. Some particular agents, depending on their hardware/software configuration, may be also able to detect obstacles in the operating space 1602 and may subsequently share the findings throughout the system's network. Advantageously, agents could monitor their environment in a continuous or interval-based way, which will enable predictive capabilities in the described methods herein used for optimal and efficient re-planning of trajectories in real-time.

A need for re-planning may arise from a detection of conflict (for example, vehicles entering or leaving the operating space, operating space violations, specific operating space restrictions, weather factors, collision avoidance, vehicle failures, the presence of non-cooperative agents, capabilities of the agents or other examples of conflicts), re-organization of coordinated agents in the system's network or on-line user demands (for example, user's request for flight plan modification). In these described scenarios, the ATMS 1502 will assess need of suggesting trajectory modification 1504 for the agents involved in a re-planning process and subsequently provide a set of optimal solutions 1505 that will resolve all potential conflicts. Recommended solutions take the form of new recommended trajectories 1506 for the agents that may face conflicts. Trajectories may be defined by recommended changes in altitude, navigation course and velocity or change in waypoints. The new trajectories can be shared by the ATMS 1502 with all users and their agents, typically through their associated GCS, in the form of recommending an action to be taken 1507 by the respective agents involved. Therefore, the users will be able to accordingly perform trajectory modifications for their affected respective agents. Additionally, the ATMS 1502 may share information on the agent environment (for example, operating space regulations, weather constraints, obstacles, other vehicles in the region and the like) with the user's GCS (for example, smartphone), for example, by using GSM networks. The shared information may be graphically displayed in the GCS via a software to be used in a GCS using a Graphical User Interfaces (GUI). The graphical display would help the users to rapidly understand different conflicts that may occur in the agent's environment.

Planning algorithms for re-planning must be optimal and dynamic in the sense to allow incorporating of different constraints in real-time. Optimal methods may include the combination of the flexible spatial region divider (FSRD) module 102 in FIG. 1A, the full dynamics envelope analysis (FDEA) module 104 in FIG. 1A, the model predictive control (MPC) module 106 in FIG. 1A or the like. Although the optimization process of a multi-input-multi-output control system is computationally demanding, current developments allow feedback times within milliseconds range, through, for example, ACADO code generation tool. The control action i.e. movement path can be calculated or generated by minimizing a cost function subject to model (relates to the model applied by the MPC module 106) and system constraints. Cost function refers to a particular function that maps an event or values of one or more variables onto a real number intuitively representing some “cost” associated with the event. Parameters to be employed in the cost may include length or time of the route, distance between agents, energy level or fuel consumption, operating space regulations, number of maneuvers, loading factors (i.e. load carried) of each agent, etc. The algorithms applied by the MPC model 106 present an advantage of projecting over a given prediction horizon as well as allowing incorporation of constraints both on inputs and states relating to agent performance capabilities, weather constraints or operating space restrictions.

Real-time information available from agents operating in the operating space may be obtained from sensors, assuming the sensors to be available on-board the agents or through a sensor suite specifically designed for such purposes. The sensor suite should be easy to integrate (for example, plug and play or integrated by the agent manufacturer), small and light. An example may include combining Global Positioning System (GPS), Inertial Measurements Units (IMU), Central Processing Unit (CPU) and GSM cellular chip in the sensor suite, however different combinations of units/parts may occur. Other example may include combining the GPS, IMU and CPU with a transmitter, such that the CPU automatically combines the GPS and IMU information with additional sourced data (for example, agent ID) to be periodically broadcasted, enabling the agent to be tracked by the ATMS (for example, 1101 in FIG. 1). Similar existing solutions include Automatic Dependent Surveillance-Broadcast (ADS-B). Such sensor suites may be provided by the ATMS 1101 with standardization purposes. For instance, different sensor suites may be approved by those operating the ATMS 1101 (for example, regulatory authorities), which integrate all the sensors needed to transmit the position, attitude, navigation course and speed in real-time to the ATMS 1101 following the ways of communication and protocols used by the ATMS 1101 and exemplified in the presently described system (i.e. 1000 in FIG. 1). Sensors such as Ultra Wide Band (UWB), Radio Positioning System (RPS), Motion Capture System (MCS), optical flow, infrared proximity, pressure or sonar sensors are all applicable and can be used with the presently described system 1000. The aforementioned sensors are applicable in GPS denied-environments, such as indoors or in areas being blocked by obstacles (for example, low altitude flights between buildings). On-board energy monitoring (for example, energy level or fuel consumption) may be reported to the ATMS 1101 to identify potential emergency situations. Moreover, additional sensors may be available on-board the agents to detect other agents, obstacles or weather conditions in their close vicinity such that the information can be spread throughout the system's network and emergency actions recommended if necessary. For example, an agent may detect obstacles by using multiple vision systems which may enable 360° viewing angle. An additional ranging sensor (for example, sonar, infrared, UWB sensors) may be used to complement the visual sensor. Other collision detection sensors are applicable including Lidar sensors, thermal sensors, acoustic sensors or millimeter wave radar. Certain types of sensors may enable direct agent to agent communication or detection of non-cooperative agents (for example, agents not connected to the network or under failure) for emergency maneuvers. This described suite may even include safety elements such as, but not restricted to, automated parachutes to be displayed in case of fatal error such that they prevent agent collision over populated areas. Civil Aviation Authorities may take advantage of this presently described system 1000 to request all agent users to be connected to the system's network, which includes the ATMS 1101 and aforementioned GCSs.

Weather may introduce dynamical constraints (i.e. weather interfering condition) that need to be determined and evaluated in real-time. For example, weather constraints may include wind, rain, heal, snow, thunderstorms, lightning, fog, haze, smoke, clouds, icing, blizzard or volcanic ash as the most common occurrences. Information about such real-time weather conditions and weather forecasts may be detected and gathered by meteorological stations, by deploying weather measurement systems for accurate data weather on sites, using internet platforms such as online weather reports or by information obtained from the agents in the operating space, but not limited to them. Real-time weather conditions and weather forecasts should be reported to the ATMS 1101. Weather information may include a time stamp and forecast to enable predictive and dynamic abilities in the ATMS 1101 (for example, a thunderstorm expanding and moving towards certain direction at certain speed).

Meteorological stations may be used for feedback purposes, which may combine different existing technologies such as satellite information, weather radar, lightening detectors, low level windshear sensors and the like. Mobile automatic weather stations may provide wind, temperature, humidity, pressure, precipitation accumulation measurements, cloud height and coverage, visibility/precipitation type and lighting measurement. An example of such stations includes the one from Vaisala's meteorological systems. Moreover, some of the agents may be equipped with different sensors with such detection capabilities including different types of cameras, lidar for clouds and mist monitoring, doppler lidar for wind monitoring, laser hygrometer for measuring water vapor in the atmosphere, pressure sensors (for example, SCP1000 Absolute Pressure Sensor from VTI Technologies), temperature and humidity sensors (for example, DigiPicco 120 manufactured by IST, SHT75 by Sensirion or Vaisala RSS901 from Vaisala Company) or small radar sensors. This information may be shared with the ATMS 1101 via wired and wireless technologies such as fiber-optic, co-axial cable, Ethernet, GSM networks and the like.

The users of agents may provide information of the capabilities of their agents under different weather conditions. For example, a standard datasheet may be provided by the ATMS 1101 for users to fill in the capabilities of their agents. The datasheet may include relevant weather phenomena, together with different thresholds. For example, wind can be classified in different levels, such as less than 10 km/h, less than 20 km/h or less than 30 km/h. Users may share with the ATMS 1101 the resistance of their agents to wind conditions by choosing one of the aforementioned levels, for example, i-user (where “i” denotes an user identifier) may share information about its agent's limitations, stating that the particular agent should not operate in wind conditions of more than 30 km/h. This information is then incorporated into the ATMS 1101 database as a constraint for the i-agent (“i” denoting agent of i-user) such that if a specific area or areas of the operating space is subjected to winds stronger than 30 km/h, it becomes considered as a “no go” zone for the i-agent. For example, areas with severe thunderstorms may be considered as a “no go” zone for all agents. These examples can be easily extended to all of the aforementioned weather conditions such that different criteria can be established according to different agent categories and weather scenarios, meaning these are the limitations of the agents in their respective environment.

FIG. 7 illustrates a logical evaluation by an ATMS 1702 in the presence of a weather interfering condition.

In an example, at step 1701, weather conditions are detected in different areas of an operating space and shared with the ATMS 1702.

At step 1703 after step 1701, the ATMS 1702 evaluates constraints. For example, evaluate whether the meteorological or weather conditions are safe for every agent to operate in the affected area or areas, or evaluate whether an affected area should be avoided for some or all of the agents based on information on different categories of agents. For instance, Category I (Cat. I) agents of a rotor type may be affected by a thunderstorm but Category II (Cat. II) of a fixed wing type will not be affected. As such, in this case, the evaluation involves defining operating constraints for the agents based on previously obtained information on the different categories of agents so as to determine whether the affected area should be avoided by the agents.

After step 1703, the ATMS 1702 decides whether a trajectory modification is required at step 1704 for agents operating in the operating space. For example, if an agent has been initially planned to navigate through the meteorological conditions evaluated as unsafe for that particular agent in step 1703, the ATMS 1702 will decide that trajectory modification is required for that agent.

Re-planning of the trajectory will be carried out by the ATMS 1702 at step 1705, if needed, such that the ATMS 1702 generates new trajectories at step 1706. Thereafter, the generated new trajectories are sent as recommended actions to the user's ground control stations (for example, GCS 1102 in FIG. 1), relayed through relay stations (for example, 1103 in FIG. 1) and/or directly to the affected agents.

At step 1707, after receiving the respective generated new trajectories, the recommended actions to proceed with the new trajectories are carried out by the affected agents if the respective users of the respective agents make a selection to agree to proceed with the new trajectories via the user's GCS.

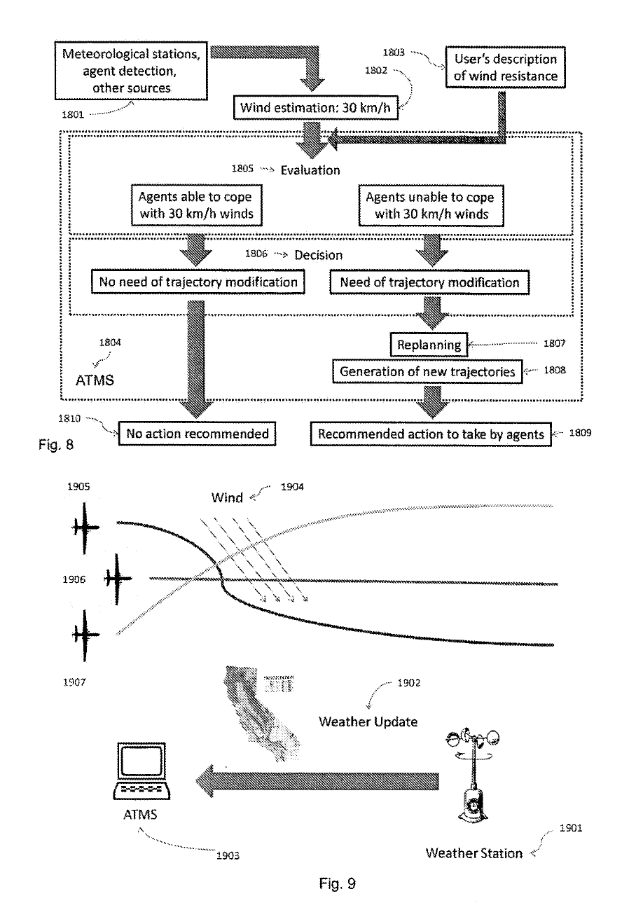

FIG. 8 illustrates a logical evaluation by an ATMS 1804 in the presence of an interfering condition such as a wind condition in an area that will affect user's agents.

In an example, meteorological stations or other agents 1801 provide wind estimations 1802 for example, 30 km/h to an ATMS 1804.

At step 1803, the user provides description of wind resistance of his/her agents via, for example, datasheets provided by the ATMS 1804 to be filled in by the user.

At step 1805, the ATMS 1804 processes the wind estimations 1802 together with the user's input of wind resistance of his/her agents to evaluate and classify the agents in the affected area as “those able to cope with the wind condition” and “those which are not able to cope with the wind condition”. As such, in this case, the evaluation involves defining operating constraints, in this case known specifically as wind constraints, for each agent based on the user's input of wind resistance of the agents so as to be able to classify the agents accordingly.

At step 1806, the ATMS 1804 takes a decision 1806 on whether each particular agent needs to modify its trajectory or not. For those which need to modify their trajectory because they are unable to cope with the 30 km/h winds, the ATMS proceeds with re-planning at step 1807 and generate a new trajectory for the affected agent or agents at step 1808. The new trajectory is then sent to the user's ground control stations (for example, GCS 1102 in FIG. 1), relayed through relay stations (for example, 1103 in FIG. 1) and/or directly to the affected agent.

At step 1809, after receiving the respective generated new trajectories, the recommended actions to proceed with the new trajectories are carried out by the affected agents if the respective users of the respective agents make a selection to agree to proceed with the new trajectories via the user's GCSs.

At step 1810, for those agents who do not need to take any action because they can cope with the 30 km/h winds, no recommendations are sent to the respective user's GCSs by the ATMS 1804. The ATMS 1804 takes no action for these agents.

FIG. 9 illustrates an ATMS 1903 transmitting recommendations of movement paths to a plurality of agents 1905, 1906 and 1907 based on a wind interfering condition.

For example, after a weather station 1901 has provided a wind forecast 1902 via a weather update to the ATMS 1903; the plurality of agents 1905, 1906 and 1907 are recommended to adopt different trajectories (i.e. movement paths) according to wind constraints defined for each of the agents 1905, 1906 and 1907. For example, if the agent 1905 has been declared by its user as not capable of handling the existing wind condition, the ATMS 1903 will recommend a trajectory avoiding the affected area with the wind condition. On the other hand, the agents 1906 and 1907 have been declared by the respective users as capable, thus recommendations are not processed.

For illustration only, another operation of the ATMS 1903 can also be to check on trajectory conformance and detect any agent's deviation from its planned trajectory. For example, the plurality of relay stations 1103 in FIG. 1 may be used with the ATMS 1903 to sense the plurality of agents 1104. The sensing may involve use of, for example, radar, Ultra Wide Band—UWB—positioning systems, satellite data or the like. Sensing includes tracking each of the plurality of agent's position, which is shared with the ATMS 1903 via the communication interface (For example, 110 in FIG. 1A) of the ATMS 1903. By comparing each of the plurality of agents' position with their respective planned trajectory, the ATMS 1903 can detect those of the plurality of agents 1104 deviating from their respective planned trajectory and classify them as non-cooperative agents (rogue agents, agents failure and the like).

With reference to FIGS. 1 and 1A, the ATMS 1101 may include a database of emergency gathering areas (not shown in the Figures) stored in the storage device 100 for one or more of the plurality of agents 1104 to navigate to one or more of the emergency gathering areas. Under special circumstances, all the agents in a particular region can be suggested to gather at the aforementioned areas. The ATMS 1101 can suggest recommendations for each particular agent on how to modify the agent's current trajectory to reach the gathering area in a cooperatively way with respect to the rest of the agents in the region. In an example, the emergency gathering areas may be emergency landing areas and the special circumstances may be “all-landing at once” scenarios. The ATMS 1101 can suggest recommendations for each particular airborne agent on how to modify the agent's current trajectory to reach the emergency landing areas in a cooperatively way with respect to the rest of the agents.

The ATMS 1101 may also include a database of power supply charging stations (not shown in the Figures) stored in the storage device 100 for the one or more of the plurality of agents 1104 to navigate to one or more of the power supply charging stations. The power supply charging stations locations may be shared with the users of the ATMS 1101. The ATMS 1101 may also suggest trajectories for agents to travel from the respective agent's current position to the power supply charging stations for those agents reporting or with reported needs for re-charging their batteries, re-fueling or the like.

For operational reasons (for example, regulatory authorities recommendations), the system 1000 presently disclosed can be N-times duplicated. For example, several ATMSs can be enabled, each covering a particular region. Information may be then shared between different ATMSs about agents crossing from one region to another using the wired and wireless technologies described above (i.e. fiber-optic or co-axial cable, GSM networks and the like) and agents and their respective GCS may be subsequently associated dynamically to a corresponding ATMS. For instance, some spatial boundaries related to each ATMS may be established such that, once an agent crosses the boundary, it will fall under the responsibility of a different ATMS. Boundaries may be dynamic, i.e. if an area presents potential conflicts, the boundary can be modified such that the conflict resolution is managed by a single ATMS 1101 and agents are not associated to the next ATMS until the conflict has been resolved.

### 4. Planning Algorithm

### 4.1 Initial Planning

With reference to FIGS. 1 and 1A, initial movement paths may need to be generated by the ATMS 1101. The ATMS 1101 may predict some potential conflicts during an operational path of the agent, which may be initially solved by a simple computational planning by the ATMS 1101. Limitations accounted for in this particular initial trajectory may include one or more interfering conditions such as static obstacles (for example, terrain and man-made objects), weather constraints, operating space restrictions, areas with heavy air traffic and the like. Static obstacles databases may be a-priori stored in the storage device 100 of the ATMS 1101. Weather constraints (i.e. weather interfering condition) may be known by the ATMS 1101 using the methods previously disclosed (for example, meteorological stations distributed across the operating space or from agents equipped with meteorological sensors, which share their information throughout the system 1000). Operating space restrictions may be known by the ATMS 1101 via the regulatory authorities. The ATMS 1101 may also predict congestions and enable safe separation at the initial planning, allowing an optimal use of the operating space. By initially avoiding conflicts, the algorithms and methods described below in section “4.2 Re-planning” shall not be used as intensively, thus, decreasing the overall system computational load. As previously mentioned, the ATMS 1101 may not recommend actions for limitations related to potential dynamic conflicts in a longer time-stamp (i.e. longer time period), such as a potential collision with an agent in a distant location. Therefore, the ATMS 1101 can intelligently generate simple trajectories at the start of the operation of the agent, without adding complexity to the system. If the conflict is still present in a future time-stamp (i.e. time period), the ATMS 1101 resolves the conflict using optimal methods that may include the combination use of the flexible spatial region divider (FSRD) module 102, full dynamics envelope analysis (FDEA) 104, model predictive control (MPC) module 106 or the like.

Congestion prediction and safe separation at the initial planning stage may be carried out by one or more routines to operate an operating space predictor module. The one or more routine is stored in the storage device 100, which is a non-transitory computer recordable medium. The one or more routines, when executed under control of the processor 108 of the ATMS 1101, evaluate a predicted position of every agent in the operating space at discrete time intervals.

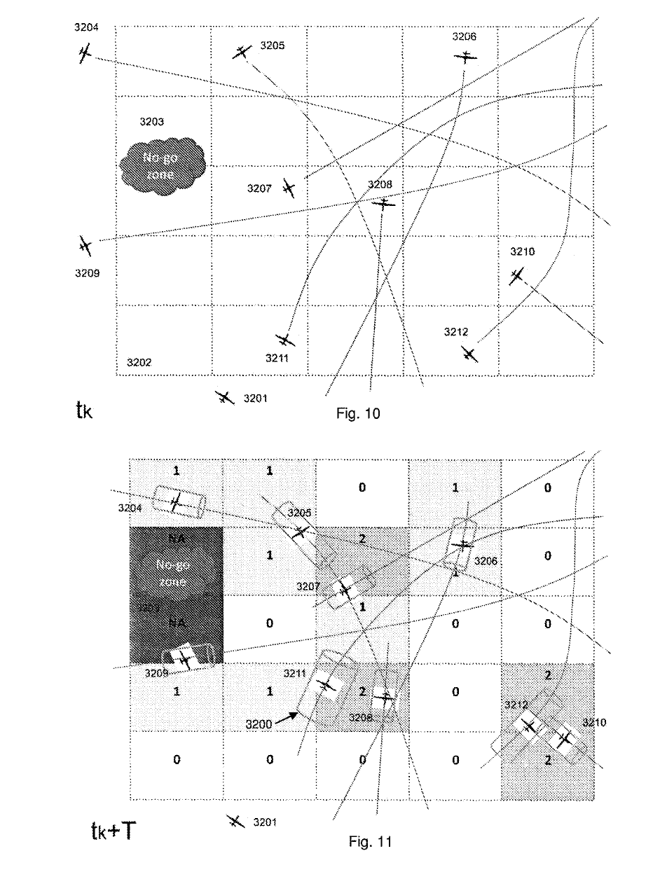

An example is illustrated in FIG. 10 to FIG. 14, where an agent 3201 is planning to operate in the operating space 3202, which includes a “no go” zone 3203 (for example, terrain and man-made objects, weather constraints, operating space restrictions or high density of non-cooperative agents) and a plurality of agents 3204-3212.

The ATMS 1101 divides the operating space into a plurality of sub-areas (refers to the plurality of squarish boundary areas in FIGS. 11 to 14), wherein each of the plurality of sub-areas is assigned an indicator (refers to the numbers 0 to 3 or NA (Not Applicable) in FIGS. 11 to 14) to indicate a degree of interference and the degree of interference depends on number of the plurality of agents in the respective sub-area.

Static or dynamic boundaries can be defined for every sub-area in the form of boundary areas in FIGS. 11 to 14. Dynamic boundaries refer to boundary areas with changing boundary shapes, size and the like, for instance, to cater to real-time changes occurring in the operating space. Static boundaries refer to those that are of predetermined shape and size and the like, for instance the “squarish” boundary areas shown in FIGS. 11 to 14. To decrease computational power, static boundaries may be used, like in the present example.

In the present example, each sub-area has an associated numeric value i.e. the indicator to indicate a degree of interference depending on the number of agents operating in that particular sub-area at a particular time-stamp. In this case, a higher number indicates that navigating into the sub-area is less advisable. Similarly, “no go” zones may have the indicator indicated as “NA” advising that the respective sub-areas should not to be operated by the agents.

Each agent has an intended trajectory and associated performance characteristics (for example, cruise speed and maximum velocity). Based on the intended trajectory and performance characteristics, an initial evaluation can be performed on where each agent is expected to be at a future time stamp.

For instance, an intended trajectory may be defined as a tangent vector τᵢ to a trajectory of an i-th agent. The cruise speed of the i-th agent may be defined as vᵢ and it may have a probabilistic error Δvᵢ associated. This probabilistic error may be related to the agent performance in the operating space (for instance, in wind conditions, Δvᵢ shall be increased). Therefore, a first approach is to define a zone 3200 (For convenience, only one zone 3200 is marked out in FIG. 11) surrounding each of the plurality of agents at a next time-stamp tₖ+T. The zone 3200 can be defined as a cylinder longitudinally delimited by (vᵢ±Δvᵢ) (tₖ+T) and laterally delimited by ±Δvᵢ (tₖ+T).

The congestion prediction algorithm applied herein evaluates the evolution of the operating space and where each of the plurality of agents is at particular time steps T. For example, at a future time-stamp tₖ+T, the aforementioned zone 3200 surrounding each of the plurality of agents 3204-3212 is generated and represented as a cylinder in FIG. 11. The dimensions of these cylinders may be different according to the performance characteristics and uncertainties in the performance characteristics associated with each agent. Cylinders of different sizes may be seen in FIG. 11 for agent 3208 (small uncertainty) and agent 3211 (large uncertainty). The algorithm may then compute the number of agents in a particular sub-area by evaluating if a part of the zone surrounding each of the plurality of agents is included in the sub-area. In FIG. 11, these numeric values are represented on every sub-area together. This information can be treated as a “4 Dimensional representation” of the operating space. Specifically, it can be observed that overlapping of a cylinder in a sub-area will increase the count of the numeric value associated with the respective sub-area. It is indicative of the degree of interference mentioned earlier. It is also indicative of presence of a predicted interfering condition to the operation of the affected respective agent.

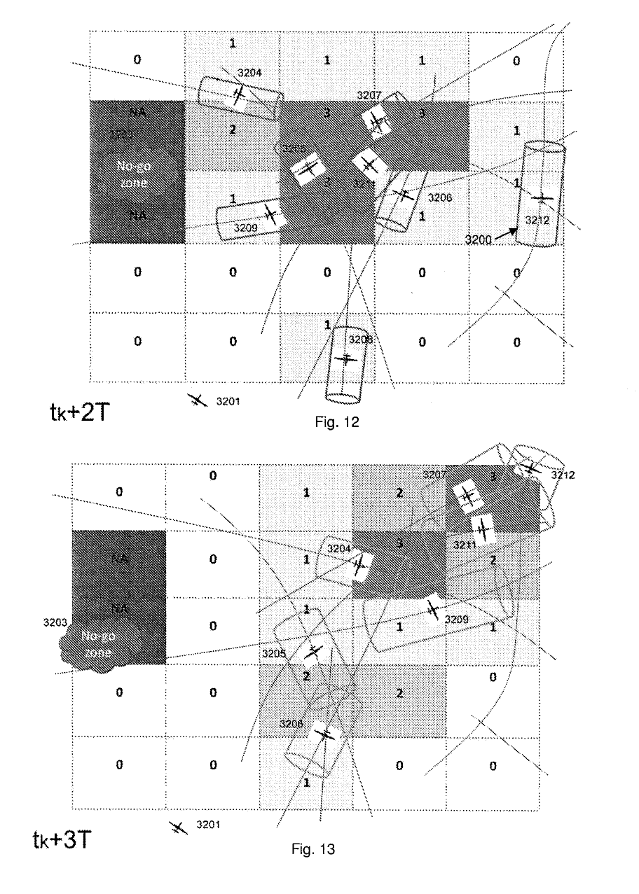

FIG. 12 represents a predicted evolution of the operating space at tₖ+2T. The “no-go” zone has been assumed to have evolved in time such that it has changed its location. Given that FIG. 12 represents a longer time-stamp than FIG. 11 with respect to the original characterization in FIG. 10, the size of the zone 3200 (For convenience, the same reference numeral for the zone 3200 in FIG. 11 is reused in FIG. 12) surrounding each of the plurality of agents (i.e. cylinders) has been increased. Similarly, numeric values are associated with every sub-area related to the predicted probability of agents being at the particular sub-area.

FIG. 13 represents a further time evolution tₖ+3T. Thresholds may be subsequently introduced such that sub-areas with an associated higher number than that of the threshold may be characterized as presenting traffic congestion (i.e. high degree of interference) and, thus, sub-areas to be avoided in the initial planning of the trajectory of agent 3201. The size of the zone 3200 (For convenience, the same reference numeral for the zone 3200 in FIG. 11 is reused in FIG. 13) surrounding each of the plurality of agents (i.e. cylinders) has been further increased.

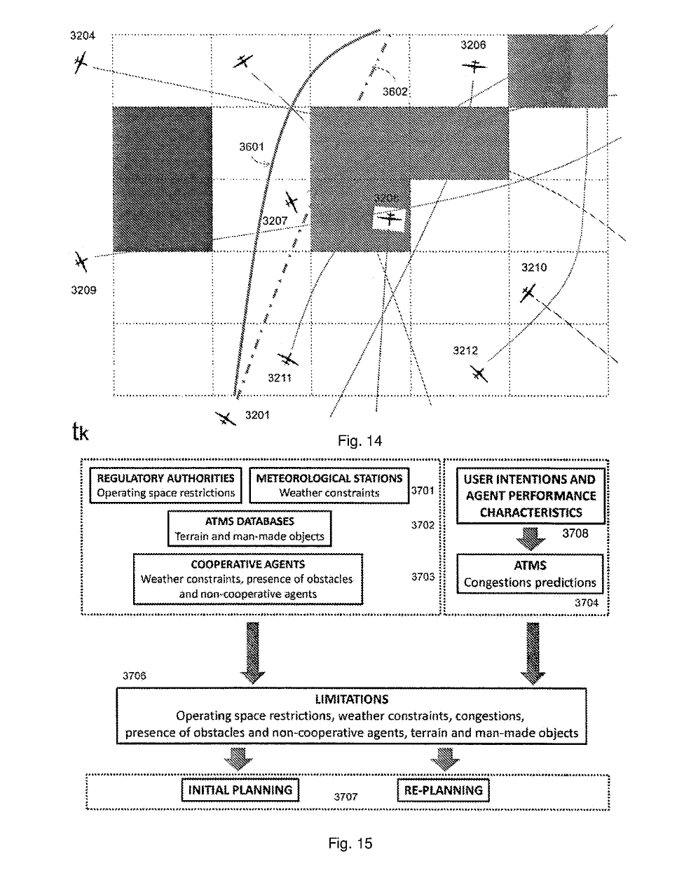

After evaluating the traffic conditions, the ATMS 1101 generates an initial movement path for each of the plurality of agents 3204-3212 in the operating space before departure of the respective agent based on the assigned indicators of the plurality of sub-areas so as to avoid areas with high traffic density and navigation into no-go zone. In this particular example, areas with “NA” tags and values higher than 2 are taken as “no-go” and congested areas, respectively. Subsequently, the agent 3201 is suggested by the ATMS 1101 in FIG. 1 to travel via a path 3601 instead of an original planned path 3602 as illustrated in FIG. 14. This suggestion resulted from a simple evaluation without taking into accounting complexities in the congested areas. The exemplified 4 dimensional maps may be dynamically generated and updated periodically (for example, 15 minutes). These maps may provide a forecast of the operating space situation at certain time steps (for example, 5 minutes) for a finite time horizon (for example, 1 hour).

With reference to FIG. 15, limitations may be obtained or generated in real-time and in a predictive manner by an ATMS 3706 by obtaining inputs from various sources. The ATMS 3706 may receive operating space restrictions and weather updates and forecasts 3701 from regulatory authorities and meteorological stations 3701 respectively. Additionally, the ATMS 3706 may include databases of terrain and man-made objects 3702 pre-stored and/or constantly updated in the storage device 100 as shown in FIG. 1A. The ATMS 3706 may also communicate with cooperating agents in the operating space, which may provide additional information 3703 on detected weather in their particular area of operation as well as on the presence of obstacles and non-cooperative agents in the same area of operation. Furthermore, the ATMS 3706 may communicate with the agents' users to obtain information on the agents preferred intentions (for example, intended trajectory) and performance capabilities (for example, planned speed) 3708. Based on the agents information provided by the users, the ATMS 3706 can predict congested areas 3704, for instance, according to the method described with reference to FIGS. 10 to 14. All of the aforementioned limitations may be dynamically updated in the ATMS 3706, which can subsequently be provided with recommendations 3707 (for example, initial planning and re-planning trajectories) accounting for the limitations.

### 4.2 Re-Planning

4.2.1 Flexible Spatial Region Divider (FSRD)

With reference to FIG. 1 and FIG. 1A, navigation paths (also known herein as movement paths) may also need to be dynamically generated by the ATMS 1101 in FIG. 1 to provide agents with real-time recommendations required to avoid conflicts or interfering conditions that may occur in an operating space. An advantage of the ATMS 1101 is the reduction of the computing complexity required to generate movement paths for a large number of agents involved. To do so, the operating space is intelligently divided into a plurality of sub-regions. The dividing of the operating space may be performed by a Flexible Spatial Region Divider (FSRD) module 102 in FIG. 1A that may include one or more routines stored in the storage device 100. The storage device 100 may be a non-transitory computer recordable medium.

The one or more routines of the FSRD module 102 may, when executed under control of the processor 108 in FIG. 1A, process information about the operating space received by the communication interface 110 in FIG. 1A to predict one or more interfering condition in the operating space. Thereafter, the FSRD module 102 divides the operating space into the plurality of sub-regions based on the predicted one or more interfering condition. One or more of the plurality of sub-regions having the predicted one or more interfering condition are then identified. Therefore, further computation (or evaluation) is narrowed to only the plurality of sub-regions having the predicted one or more interfering condition. The one or more of the plurality of agents present in each of the plurality of sub-regions having the predicted one or more interfering condition will be subject to further evaluation.

Each of the plurality of sub-regions is flexible in size and flexible in the number of agents present in each sub-region. That is, depending on circumstances, each sub-region may have different sizes and contain any number of agents operating in the operating space. Examples for sub-region sizing will be described later.

After the FSRD module 102 divides the operating space into the plurality of sub-regions, information of each of the plurality of sub-regions having the predicted one or more interfering condition, including information of each agent in the sub-region having the predicted one or more interfering condition can be passed to the FDEA module 104 in FIG. 1A (described later with reference to section “4.2.2 Full Dynamics Envelope Analysis”) and the MPC module 106 in FIG. 1A (described later with reference to section “4.2.3 Model Predictive Control”) to generate collision-free, conflict-free or interference-free trajectories comprising movement paths in each of the plurality of sub-regions for the one or more of the plurality of agents in each sub-region having the predicted one or more interfering condition.

The generation of the plurality of sub-regions is based on the predicted one or more interfering condition. The predicted one or more interfering condition may include, but not limited to, conflict likelihood, agents separation, agents angle of convergence, maneuver options available in a conflict situation, agents variance with respect to the agents nominal operation, ground population, operating space restrictions, weather constraints, traffic congestions, presence of obstacles and non-cooperative agents, terrain and man-made objects, agents failures, maximum number of agents in each plurality of the sub-regions, volume of each of the plurality of sub-regions or a combination of any of the above. The performance capabilities of the agents may be another factor that may affect the generation of the plurality of sub-regions, when taken alone or in combination with any of the above predicted one or more interfering condition. The plurality of sub-regions are dynamically generated, which allows to accommodate limitations such as operating space restrictions, weather constraints, congestions, presence of obstacles and non-cooperative agents, terrain and man-made objects and the like. The aforementioned limitations may be generated in a short period of time and in real-time by the ATMS 1101. The ATMS 1101 may also include a forecast of the evolution of the aforementioned limitations and utilize such limitations to better re-route the movement paths of each of the plurality of agents in each of the plurality of sub-regions having the predicted one or more interfering condition accounting for the forecast future evolution of the limitations.

The communication interface 110 receives information about the operating space from a plurality of ground control stations and/or the plurality of agents in the operating space, wherein each of the plurality of ground control stations is configured for controlling and monitoring a group of the plurality of agents. The communication interface 110 may also receive information about the operating space from a plurality of relay stations, users of the plurality of agents, and/or other relevant parties (for example, Civil Aviation Authorities, meteorological stations, and similar governmental, private or corporate parties) though a network enabled device (for example, 1209 in FIG. 2).

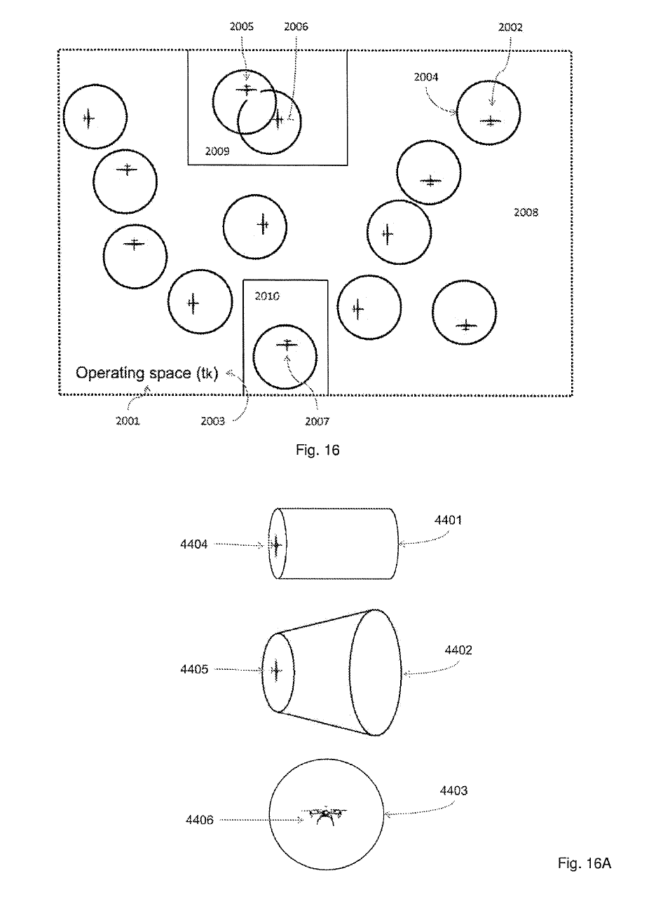

FIG. 16 illustrates an example of use of the Flexible Spatial Region Divider (FSRD) module 102 in FIG. 1A to reduce computational data for processing by the processor 108 in FIG. 1A. FIG. 16 shows an operating space 2001 having a plurality of agents 2002 at time tₖ 2003. The present example is represented in a two-dimensional space for simplicity reasons. In an actual application of the ATMS 1101 in FIG. 1, it is appreciated that the operating space 2001 may be easily extended to three-dimensional space by considering altitude of the plurality of agents 2002.

It is assumed that the FSRD module 102 is operated at every time step T to generate data relating to a current status of the operating space 2001 i.e. real-time processing. Each status of the operating space 2001 will include data of at least the current positions of the plurality of agents 2002 in the operating space 2001. There may be other data in the status of the operating space 2001 such as a zone around each agent (which will be described as follows), intended trajectory, navigation course, speed, etc. To illustrate the present example, the time tₖ 2003 is regarded as initial time.

Although the FSRD module 102 in the present example is used to generate data relating to current status of the operating space 2001 i.e. in real time, it is possible in another example that the FSRD module 102 is used to generate data at every time step T for predicting future status (for example, a few seconds or minutes later) of the operating space 2001 based on pre-planned trajectory information of the plurality of agents 2002 obtained by the ATMS 1101.

When the FSRD module 102 is operated for tₖ 2003, a zone 2004 surrounding each of the plurality of agents 2002 to represent the evolution of an agent in a defined time interval is generated. Evolution of the agent refers to a volume in which the agent is expected to be at that particular time tₖ. The zones 2004 (For convenience, 2004 in FIG. 16 will refer to both a single zone and to a plurality of zones.) around each of the plurality of agents 2002 are evaluated. The evaluation of the zones 2004 checks whether there are potential conflicts or interfering conditions that would require re-planning of movement paths of the plurality of agents 2002 to avoid the potential conflicts or interfering conditions.

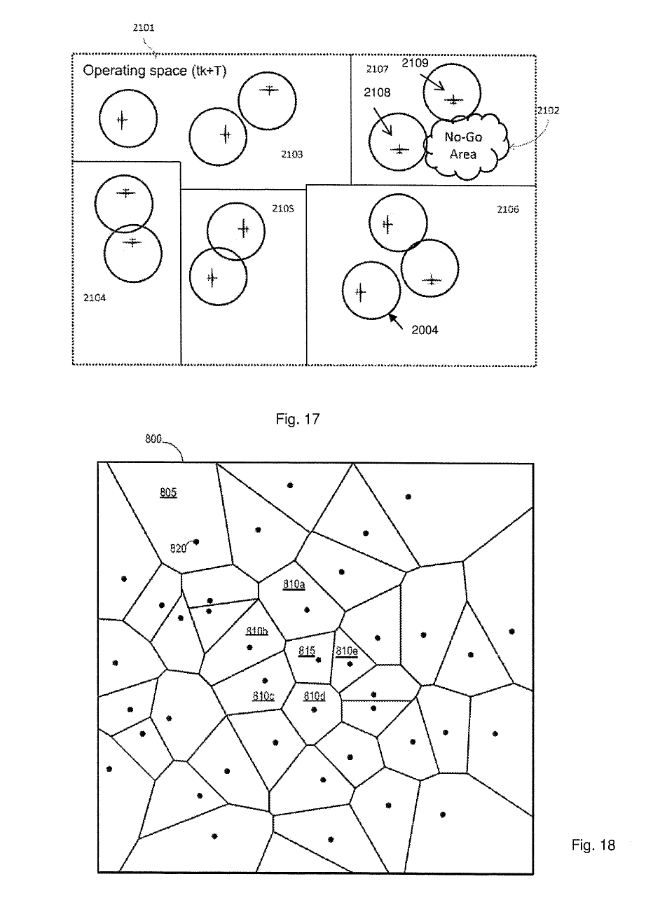

The zone 2004 surrounding each of the plurality of agents 2002 may have a shape similar to the zone 3200 in FIGS. 11 to 13 defined above for the congestion prediction algorithm (refer to section “4.1 Initial Planning”). Alternatively, the zone 2004 can be defined as a sphere created around a current position of each of the plurality of agents 2002, which is the case for the present example illustrated with reference to FIG. 16 and FIG. 17. The sphere has a radius R=vₘₐₓT, where vₘₐₓ is the maximum velocity of the respective plurality of agents 2002.

Furthermore, different shapes of the zone 2004 may be used. Examples are shown in FIG. 16A, which illustrates cylindrical 4401, tronco conical 4402, and spherical 4403 shaped zones. These zones illustrate different points that can be reached by an agent starting at a predetermined position in a determined time interval (for example 4404-4406 for 4401-4403, respectively). For instance, for agents that are fixed-wing Unmanned Aerial Vehicles, zone shapes of the form 4401 and 4402 may be advisable, whereas for agents that are multi-copters, zone shapes of the form 4403 may be more advisable.

Referring back to FIG. 16, to illustrate prediction of one or more interfering condition, for example, specific agents 2005 and 2006 are entering into a potential conflict (for example, possible collision) as they are located very close to each other and their movement paths appear that they may collide if they continue in their pre-planned paths. Intersection of the zones 2004 of the agents 2005 and 2006 may be used as an indicator to predict this potential conflict as an interfering condition. Another example includes a specific agent 2007 that may have reported an emergency situation such as low energy level and need for landing. As such, from the reporting, the present emergency situation is predicted to be an interfering condition.

After obtaining data of the predicted one or more interfering condition, the ATMS 1101 then uses the FSRD module 102 to create three different sub-regions 2008, 2009 and 2010. The first one including a sub-region 2008, where no action is needed to be taken by each of the plurality of agents 2002 in the sub-region 2008 during the mentioned time interval tₖ 2003, whereas the other two sub-regions 2009 and 2010 would need further evaluation. Specifically, the sub-region 2009 is created to filter out or isolate a sub-region covering the specific agents 2005 and 2006, which have a potential collision problem in their pre-planned paths. The sub-region 2010 is created to filter out or isolate a sub-region covering the specific agent 2007, which has reported to have the emergency situation. In this way, the computational load of evaluating the entire operating space 2001, which is one way of determining whether there are interfering conditions for each agent, has been decreased to simple evaluation of just the smaller sub-regions 2009 and 2010 at time interval tₖ 2003. Further evaluation may also include processes undertaken by the FDEA module 104 in FIG. 1A and the MPC module 106 in FIG. 1A, which will be discussed in detail later, to define operating constraints for each agent in the sub-regions 2009 and 2010 and to generate movement paths for each agent in sub-regions 2009 and 2010.

FIG. 17 represents evolution of the operating space 2001 in FIG. 16 at a next time interval after the initial time tₖ 2003 in FIG. 16 i.e. tₖ+T 2101. Similarly, the ATMS 1101 uses the FSRD module 102 for tₖ+T 2101. In the current status of the operating space 2001, it can now be seen in FIG. 17 that there are 3 potential agent collisions based on intersection of zones 2004 (For convenience, the same reference numeral for the zone or zones 2004 in FIG. 16 is reused in FIG. 17 and it represents the zones of all agents in the operating space 2001) of respective agents in the operating space 2001. Furthermore, there is inclusion of a “no go” (also known herein as “no-access”) area 2102 which may represent unfavorable weather condition that has developed between tₖ 2003 to tₖ+T 2101. In FIG. 17, two agents 2108 and 2109 are “close” to the “no go” area 2102. In particular, “close” in the present example refers to the zones 2004 of the agents 2108 and 2109 intersecting with a contour approximated by the ATMS 1101 for the “no go” area 2102. Hence, in this case, there are 5 predicted interfering conditions, namely 3 potential agent collisions and 2 agents 2108 and 2109 close to the “no go” area 2102 at tₖ+T 2101. The operating space 2001 is therefore divided into 5 sub-regions 2103 to 2107 by the FSRD module 102, wherein sub-region 2103 is not representing any conflict, sub-regions 2104 to 2106 are presenting potential agent collision situations, which may require re-routing of the affected agents, and a last sub-region 2107 including a “no go” sub-region which requires constant monitoring and possible re-routing of the affected agents 2108 and 2109 to avoid the “no go” area 2102.

Sub-region boundaries may be defined at every time interval T once the conflicting sub-regions (i.e. sub-regions having predicted one or more interfering condition) have been created as described with reference to FIG. 16 and FIG. 17 above. As an example, Voronoi diagrams may be used to make partitions of a volume into sub-regions based on distance between agents and limitations (i.e. operating space restrictions, weather constraints and the like) in a specific subset of the volume.

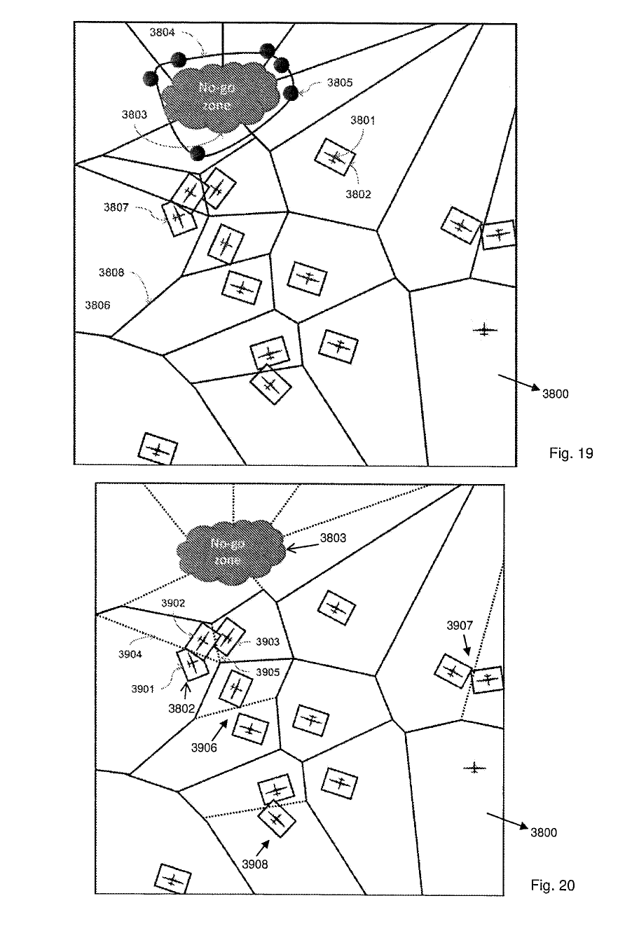

Hence, with reference to the aforementioned description, as the FSRD module 102 processes information about the operating space 2001 received by the ATMS 1101 via its communication interface 110 in FIG. 1A to predict one or more interfering condition in the operating space 2001, the FSRD module 102 determines a zone 2004 surrounding each of the plurality of agents 2002 in the operating space, determines whether the zones 2004 surrounding each of the plurality of agents 2002 intersect with each other, and predict presence of the one or more interfering condition if the zones 2004 intersect with each other. In addition, the FSRD module 102 is configured to determine a no-access zone (i.e. the “no go” zone 2102) in the operating space 2001 based on the information about the operating space 2001 received by the communication interface 110, determine one or more reference points approximating the contour of the no-access zone, determine whether a zone 2004 surrounding each of the plurality of agents intersects with the contour of the no-access zone, and predict presence of the one or more interfering condition if the zone 2004 surrounding the plurality of agents 2002 intersects with the contour of the no-access zone. Approximation of the contour (i.e. 3804 in FIG. 19) will be discussed in more detail in FIG. 19.

FIG. 18 illustrates a Voronoi diagram of a predetermined operating space 800. The Voronoi diagram is also referred to as Dirichlet tessellations, and the cells are called Dirichlet regions, Thiessen polytopes, or Voronoi polygons. Mathematically, consider a collection of n>1 agents in a convex polytope Ω, with pᵢ ∈Q denoting positions of the agents. A set of Dirichlet regions (P)={Vᵢ, . . . , Vₙ}, Vᵢ⊂Q is a Voronoi partition, generated from the set P={pᵢ, . . . , pₙ} if Vᵢ={q∈Q:∥q−pᵢ∥<∥q−pⱼ∥,∀j≠i} where ∥·∥ is the Euclidean norm. If pᵢ is the (Voronoi) neighbor of pⱼ or vice versa, the Voronoi partitions Vᵢ and Vⱼ are adjacent and share an edge. The edge of a Voronoi partition is defined as a locus of points equi-distant to the two nearest agents. The Voronoi neighbors of pᵢ is denoted by N(i); and j∈N(i) if and only if i∈N(j). Two agents are neighbors if they share a Voronoi edge. An agent would decide which agents within its sensing range to interact with based on the Voronoi diagram.

At every iteration, for example, at every time interval T in the examples described with reference to FIG. 16 and FIG. 17, a new Voronoi diagram may be generated. In the representation in FIG. 18, the operating space 800 can be divided into a plurality of cells (known collectively as 805). For the clarity of presentation, each of the plurality of cells 805 can be populated with one agent 820, represented by a dot. Selected cells 810a-810e can be identified as neighboring cells of preselected cell 815. A new divider can be drawn to flexibly divide the operating space 800 into a new array of cells. For example, a first cell may be divided from a corner of the operating space 800, and the neighboring cells may be sub-divided until all cells are covered. In the present example, each cell is populated with six agents. However, the number of cells and agents in a cell may be modified based on computational power of the ATMS 1101. In this manner, the method carried out by the FSRD module 102 may include determining cell boundaries based on the Voronoi partition as described above.

In the use of the Voronoi diagram of FIG. 18, the agents' locations and limitations (i.e. operating space restrictions, weather constraints and the like), hereinafter called seeds, are specified beforehand. For each seed, the FSRD module 102 creates a corresponding Voronoi cell comprising all points closer to that respective seed than to any other seed. An example of the use of the Voronoi diagram is illustrated in FIGS. 19 to 21.

FIG. 19 shows a plurality of agents 3801 with respective zones 3802 (For convenience, a single zone will also be known as 3802) surrounding each of the plurality of agents in an operating space 3800. Each of the zones 3802 is similar to the zone 2004 in FIG. 16 and FIG. 17. A “no go” zone 3803 similar to the “no go” zone 2102 in FIG. 17 exists in the operating space of FIG. 19. This “no go” zone 3803 may be approximated by the FSRD module 102 in FIG. 1A as a contour 3804 defined as a series of reference points 3805 surrounding or around the “no go” zone 3803. The reference points 3805 defining the contour 3804 are taken as seeds for the Voronoi diagram generation. After approximating the contour 3804, numerous Voronoi cells known collectively as 3806 in FIG. 19 are subsequently created by the FSRD module 102 for respective seeds (referring to each of the plurality of agents and known collectively as 3807) and for the reference points 3805 (which are also seeds). The underlying principle of a Voronoi partition described with reference to FIG. 18 is applied in the creation of the Voronoi cells. That is, an edge (all edges in FIG. 19 are known collectively as 3808) of a Voronoi partition is defined as a locus of points equi-distant to two nearest seeds.

With reference to FIG. 20, in a further step, the FSRD module 102 evaluates areas in the operating space 3800 in FIG. 19 presenting conflicts or interfering conditions such as the “no go” zone 3803 or conflicting agents. Conflicting agents or agent refer to agents or agent affected or potentially affected by one or more interfering condition such as a collision with another agent. An example of conflicting agents facing potential collision is agents 3901 to 3903 in FIG. 20. As the Voronoi cells of these conflicting agents 3901 to 3903 are adjacent to one another and the respective zones 3802 (The same reference numeral for zone or zones 3802 in FIG. 19 is reused in FIG. 20) of the agents 3901 to 3903 are intersecting one another, the Voronoi cells belonging to each of the conflicting agents 3901 to 3903 are merged together to form a larger sub-region for further evaluation. In addition to conflicting agents 3901 to 3903, there are 3 other pairs, namely 3906, 3907 and 3908, of conflicting agents also present in FIG. 20 resulting in merging of Voronoi cells belonging to each of the affected conflicting agents.

Further evaluation may include, for instance, processing information of the conflicting agents and their associated data (for example, position, altitude, navigation course and speed) by the FDEA module 104 in FIG. 104 and the MPC module 106 in FIG. 106.

Similar to Voronoi cells with conflicts, the free-of-conflict Voronoi cells are merged together to form larger sub-regions and no further evaluation is required for these free-of-conflict sub-regions. An example shown in FIG. 20 is the merging of all Voronoi cells adjacent to the “No go” zone 3803, which does not contain any conflicting agent.

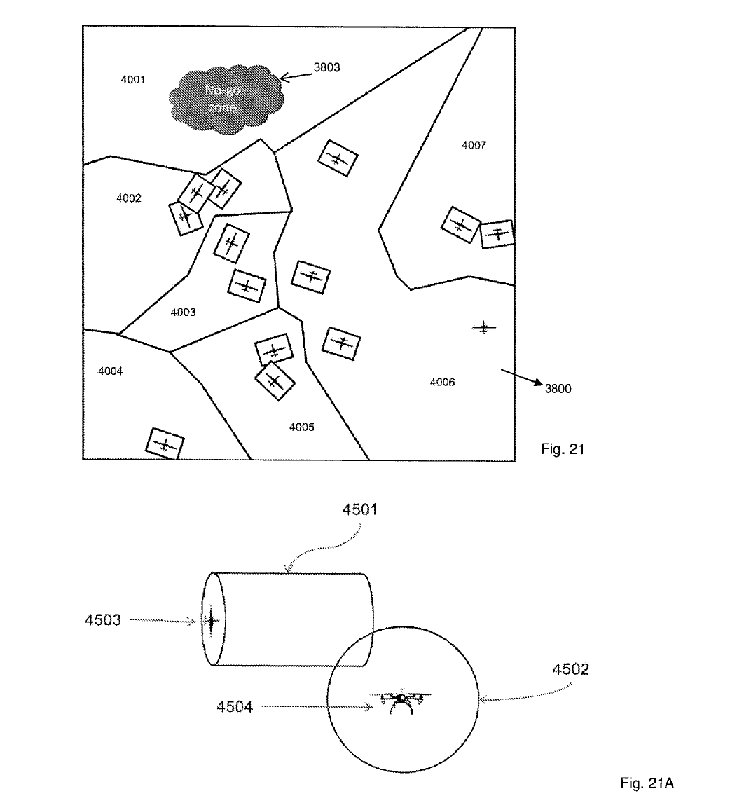

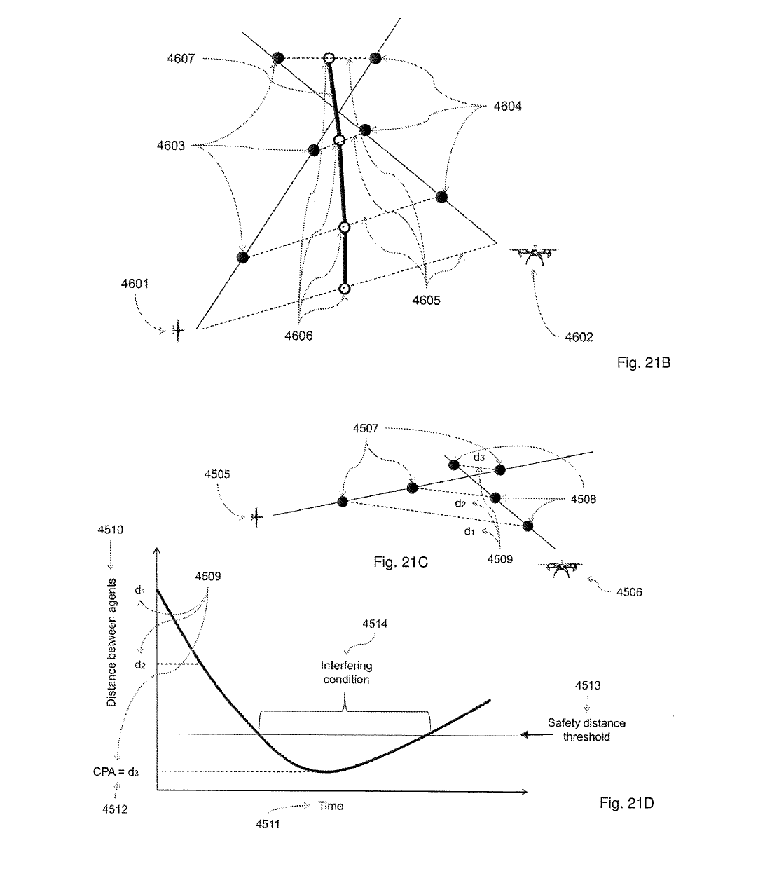

After carrying out the method steps described with reference to FIG. 19 and FIG. 20, the FSRD module 102 thus provides final sub-regions divided out for the operating space 3800 as shown in FIG. 21, which are merged as described earlier. The merged and final sub-region 4001 would require constant monitoring as the “No go” zone 3803 may move or worsen if, for instance, it is a weather condition. Sub-region 4002 (merged cell of the conflicting agents 3901 to 3903 in FIG. 20), 4003 (merged cell of conflicting agent pair 3906 in FIG. 20), sub-region 4005 (merged cell of conflicting agent pair 3908 in FIG. 20) and sub-region 4007 (merged cell of conflicting agent pair 3907 in FIG. 20) require further evaluation. Finally, remaining sub-regions 4004 and 4006 divided out of the operating space 3800 require no further evaluation. Similarly, further evaluation discussed here may include, for instance, processing information of the conflicting agents by the FDEA module 104 in FIG. 1A and the MPC module 106 in FIG. 1A.

Furthermore, sub-regions unable to be classified as “No go” zones yet and requiring constant monitoring may be classified differently as a monitoring zone from other classes such as “No go” zones and zones surrounding agents. An example would be a weather condition that may potentially turn out to be an interfering condition. Information of such monitoring zones may also contribute to operating constraints processed by the FDEA module 104 and the MPC module 106 in FIG. 1A for those agents operating in the respective sub-region having the monitoring zone. As such, the FSRD module 102 may be further configured to determine a monitoring zone in the operating space 3800 based on information about the operating space 3800 received by the respective ATMS (for example, 1101 in FIG. 1) via a communication interface (for example, 110 in FIG. 1A) of the ATMS; and monitor the monitoring zone to determine whether the monitoring zone has to be changed into an interfering condition.

It is appreciated that other suitable ways to identify conflicting agents other than intersecting zones may also be employed. The FSRD module 102 can apply just one of the ways for predicting one or more interfering condition (for example, to identify conflicts of conflicting agents) or apply more than one ways together. For illustration purposes, the pair 3906 in FIG. 20 of conflicting agents are deliberately determined or predicted herein to be facing an interfering condition not by way of intersection of respective zones 3802 of the conflicting agents. Rather, another different way is used to evaluate conflict between this pair 3906 of agents. This other way is known herein as a Closest Point of Approach (CPA) method.

The CPA method is described with reference to FIGS. 19 to 21 as follows. That is, the one or more routines of the FSRD module 102 may when executed under control of the processor 108 in FIG. 1A: determine a value indicative of closest distance between the two agents 3906 of the plurality of agents 3801 along pre-determined movement paths of the two agents 3906 in the operating space 3800; and predict presence of the one or more interfering condition by comparing the value with a threshold value. For example, a value lower than or equal to the threshold value (for example, value=0 refers to a collision between agents or value=1 refers to the agents are too close to each other and may be dangerous) may indicate that the two agents 3906 are too close and thus indicate presence of an interfering condition.

More details on the various ways to determine conflict or one or more interfering condition are as follows. An example can be found in FIG. 21A where two agents 4503 and 4504 with envelopes or zones 4501 and 4502, respectively, intersect with each other and such intersection denotes an interfering condition.

With reference to FIG. 210, another example refers to the CPA method. In this case, two agents 4505 and 4506 are considered. The CPA method evaluates the path followed by each respective agent at discrete time intervals 4507 and 4508, respectively. Based on such discretization, distances between the predicted positions of each agent at those time steps (for example, d₁, d₂ and d₃ in the example shown in FIG. 210) are calculated. By defining a value of closest point of approach (CPA value) as a minimum of the aforementioned distances (for example, d₃ in FIG. 21C), a threshold can be defined such that if the CPA value is less than the threshold, an interfering condition will be determined.

The example in FIG. 21C is further illustrated in FIG. 21D, which includes a graphical representation of the distance 4510 between the agents 4505 and 4506 as a function of time 4511. Distances between the predicted positions of each agent at discrete time steps (for example, d₁, d₂ and d₃ in the example shown in FIG. 210) are included in FIG. 21D as 4509. The CPA value is defined as the minimum distance between the agents during their operation, i.e. d₃ 4512 in FIG. 21D. By comparing the distance 4510 between agents during their operation with a safety distance threshold 4513, which defines a safety distance to maintain between the agents, a time interval 4514 in the graphical representation where the distance 4510 between the agents is lower than the safety distance threshold 4513 can be determined to be one interfering condition.

One of the limitations of the Voronoi diagrams described earlier with reference to FIGS. 18 to 21 is that they account for the distance between agents, but not for the trajectory or the speed the agent travels. An approach to overcome such situations (and, therefore, generate FSRD sub-regions) is illustrated in FIG. 21B. FIG. 21B shows two agents 4601 and 4602 together with their planned paths defined by a set of discrete waypoints 4603 and 4604, respectively, which represent the predicted position of each agent at a predefined time step. By determining the straight lines 4605 connecting the agents position at each of the predefined time steps and calculating the middle point of such segments 4606, a boundary (similar to the ones generated by the Voronoi diagrams) can be defined connecting all the middle points. The process of FIGS. 19-21 can be subsequently repeated.

FIG. 37 illustrates an example on the different boundaries generated using the Voronoi diagrams and the method previously described. It is first assumed that two agents 4701 and 4702 follow parallel paths. The Voronoi diagram will generate a boundary 4704, which does not account for the agents trajectory. However, the method previously described will generate a boundary 4703 clearly accounting for the agents trajectory.

Hence, with reference to FIGS. 19-21, the FSRD module 102 in FIG. 1A can be configured to divide the operating space 3800 into a plurality of sub-regions 4001-4007 based on the predicted one or more interfering condition by:
dividing the operating space 3800 into a plurality of cells (for example, the Voronoi cells 3806 in FIG. 19), wherein each of the plurality of cells corresponds with a corresponding agent in the plurality of agents 3801; and
merging a first set of cells (i.e. cells with conflicts that may include two or more cells) to form a sub-region (for example, 4002, 4003, 4005, and 4007) of the plurality of sub-regions if the predicted one or more interfering condition affect the corresponding agents (for example, 3901-3903, 3906, 3908 and 3907) in the first set of cells.

The FSRD module 102 in FIG. 1A can also be configured to merge a second set of cells (i.e. cells without conflict that may include two or more cells) to form a sub-region (for example, 4004 and 4006) of the plurality of sub-regions if none of the predicted one or more interfering condition affect the corresponding agents (for example, the agents other than 3901-3903, 3906, 3908 and 3907 in FIG. 20) in the second set of cells.

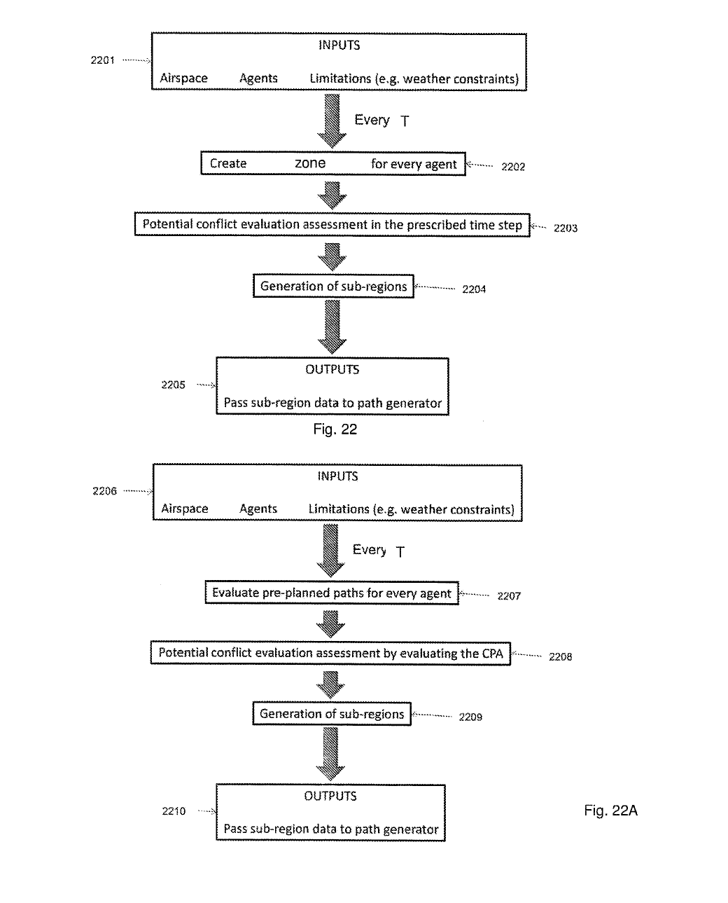

An example of a method of FSRD algorithm using intersecting zone information of agents to predict one or more interfering condition carried out by the FSRD module 102 in FIG. 1A is illustrated in FIG. 22. The FSRD algorithm may be one or more routines stored in a non-transitory computer recordable medium such as the storage device 100 in FIG. 1A to be periodically executed under control of the processor 108 in FIG. 1A.

At step 2201, the information of an operating space such as agents (determined by its location, altitude, speed, navigation course, etc.) and limitations (for example, operating space restrictions, weather constraints, presence of obstacles or capabilities of the agents) are received by the communication interface 110 or/and initially stored in the storage device 100 in FIG. 1A as inputs from a plurality of ground control stations, a plurality of agents in the operating space, a plurality of relay stations, users of the plurality of agents, and/or other relevant parties (for example, Civil Aviation Authorities, meteorological stations, and similar governmental, private or corporate parties) though a network enabled device (for example, 1209 in FIG. 2).

At step 2202, at every predetermined time interval T, a zone (for example, 2004 in FIGS. 16 and 3802 in FIG. 19) surrounding each of the plurality of agents is created or determined for every agent present in the operating space based on the inputs of step 2201. Other zones that may be created would be the “no go” zone (for example, 3803 in FIG. 19) or the monitoring zone described earlier.

At step 2203, the zone information of every agent determined at step 2202 and the information of step 2201 are subsequently used to evaluate any potential conflict i.e. to predict one or more interfering condition. For instance, intersection of zones indicates presence of an interfering condition.

After the one or more interfering condition is predicted, a plurality of sub-regions is generated at step 2204 according to the methods described with reference to FIGS. 16 to 21. The plurality of sub-regions at step 2204 is generated (for example, using the Voronoi diagram method described earlier) for areas having conflicting agent or agents, for “no go” areas, and for areas which require constant monitoring such as those with operating space restrictions, weather constraints, obstacles or similar.

At step 2205, the generated sub-region data output from the FSRD module 102 are transmitted to the FDEA module 104 in FIG. 1A and the MPC module 106 in FIG. 1A (i.e. path generator in FIG. 22) for further processing.

Once the plurality of sub-regions have been generated, data may be associated with each of the plurality of sub-regions such as position, altitude, navigation course or speed of the agents in the sub-region, identifiers, type of agent (for example, model and year), performance capabilities (for example, maximum speed and acceleration), disturbance resistance (for example, wind resistance), range or endurance. The agent or agents present in each sub-region having one or more interfering condition is/are to be further evaluated. The sub-region data generated by the FSRD module 102 is used by the ATMS 1101 for performing full dynamics envelope analysis (FDEA) carried out by the FDEA module 104 for every conflicting agent and for generating a movement path for each conflicting agent using the MPC module 106.

An example of a method of FSRD algorithm using the CPA method to predict one or more interfering condition carried out by the FSRD module 102 in FIG. 1A is illustrated in FIG. 22A. The FSRD algorithm may be one or more routines stored in a non-transitory computer recordable medium such as the storage device 100 in FIG. 1A to be periodically executed under control of the processor 108 in FIG. 1A. Steps 2206, 2209 and 2210 in FIG. 22A are similar to the steps 2201, 2204 and 2205, respectively, in FIG. 22 and the corresponding description of the steps 2201, 2204 and 2205 with reference to FIG. 22 shall apply to the Steps 2206, 2209 and 2210 in FIG. 22A, respectively. However, step 2207 occurring after step 2206 is different from step 2202 in FIG. 22 and step 2208 occurring after step 2207 is different from step 2203 in FIG. 22. Instead of creating zones surrounding each agent like in step 2202, the step 2207 involves evaluation of pre-planned paths for every agent. These pre-planned paths are information obtained by an ATMS (for example, 1101 in FIG. 1) used to run the FSRD algorithm and the evaluation is carried out by the FSRD module 102 in FIG. 1A of the ATMS. Instead of using zone information for potential conflict evaluation like in step 2203, the step 2208 involves evaluation of potential conflict using the CPA method as described earlier. As described earlier, the CPA method determines a value indicating closest distance between two agents based on information of the pre-planned paths and compares the value with a threshold value to decide whether there is any potential conflict.

An advantage of the FSRD module 102 is that it may be used to convert a computationally-heavy multi-agent coordination problem into a computationally-feasible one. By dividing one big region into several sub-regions, the number of agents that are calculated by the path generator or the navigation system may be reduced, hence reducing the computational time. As the FSRD module 102 intelligently divides the multiple agent operation space into smaller sub-regions and isolates or filters one or more sub-regions containing one or more agents that truly require attention, multi-agent coordination by the ATMS 1101 thus becomes feasible and is made possible to be performed in real-time. With the method provided by the FSRD module 102, an “entire centralized formation” movement challenge or difficulty is divided into decentralized subsystems. Information of each sub-region is passed to a path generator (for example, the MPC module 106 in FIG. 1A) in a way that the sub-region data of each sub-region can be processed separately by the path generator to generate collision-free trajectories forming paths of movement of the agents.

4.2.2 Full Dynamics Envelope Analysis (FDEA)

The FDEA module 104 in FIG. 1A aims to prevent loss of control of one or more agents in an operating space 1105 in FIG. 1 by using envelope protection, i.e. by preventing agents from exceeding a safe agent maneuver envelope. In the context of airborne agents, a flight envelope protection is a human machine interface extension of an aircraft's control system that prevents the pilot of an aircraft from making control commands that would force the aircraft to exceed its structural, aerodynamic or operational limits. Before applying the envelope protection, the ATMS 1101 in FIG. 1 may require knowledge of the maneuver envelope, both to safeguard loss of control events and not to place too conservative operating constraints on an agent's performance.

For example, poor knowledge of the maneuver envelope of an agent may motivate the ATMS 1101 to take a conservative approach and prevent the agent from making use of its full capabilities. However, good knowledge of the maneuver envelope of the agent may allow the ATMS 1101 to exploit limits of the agent's dynamics and, therefore, allow aggressive maneuvers (if required), which may help to optimize the use of the operating space 1105 in FIG. 1. The Safe Agent Maneuver Envelope (SAME) can be defined as part of a state space (i.e. set of values that a process can take) for which safe operation of the agent can be guaranteed and external constraints will not be violated. SAME may be defined as the intersection of four envelopes: dynamic envelope, formation envelope, structural envelope, and environmental envelope. SAME will provide operating constraints to each of a plurality of agents.

Dynamic envelope refers to operating constraints posed by dynamic behavior of an agent, due to its aerodynamics and kinematics. For example, agent's maximum speed may be included in the dynamic envelope. The one or more routines of the FDEA module 104 in the ATMS 1011 may when executed under control of the processor 108: analyze dynamics of each conflicting agent in each sub-region having predicted one or more interfering condition (divided by the FSRD module 102) of the operating space 1105; and define the operating constraints for each assigned agent based on the analyzed dynamics.

Formation envelope refers to operating constraints due to inter-agents connections, which can be significant when an agent is in a formation flight group, depending on its neighborhood agents' state and the formation topology. There may be additional constraints like inter-agents collision avoidance, formation keeping and connection maintaining. For example, a minimum distance separation between agents may be included in the formation envelope. The one or more routines of the FDEA module 104 in the ATMS 1011 may when executed under control of the processor 108: analyze movement formation that each conflicting agent is configured to form in each sub-region having predicted one or more interfering condition (divided by the FSRD module 102) of the operating space 1105; and define the operating constraints for each conflicting agent based on the analyzed movement formation.

Structural envelope refers to operating constraints posed by the frame material, structure and similar of each of the plurality of agents. For example, the maximum load each of the plurality of agents can safely handle during a maneuver may be included in the structural envelope. The one or more routines of the FDEA module 104 in the ATMS 1011 may, when executed under control of the processor 108: analyze structure of each conflicting agent in each sub-region (divided by the FSRD module 102) having predicted one or more interfering condition of the operating space 1105; and define the operating constraints for each conflicting agent based on the analyzed structure.

Environmental envelope refers to operating constraints due to the environment in which an agent operates, including wind conditions, constraints on terrain and “no go” zones. For example, a range of horizontal coordinates where the agent can safely operate without colliding with man-made objects may be included in the environmental envelope. The one or more routines of the FDEA module 104 in the ATMS 1011 may when executed under control of the processor 108: analyze environmental conditions surrounding each conflicting agent in each sub-region (divided by the FSRD module 102) having predicted one or more interfering condition of the operating space 1105; and define the operating constraints for each conflicting agent based on the analyzed environmental conditions.

Considering dynamics of an agent during an extreme formation maneuver can involve both the dynamic envelope and formation envelope. For example, operating constraints posed on the agent can be a maximum bank angle when an airborne agent flies forward.

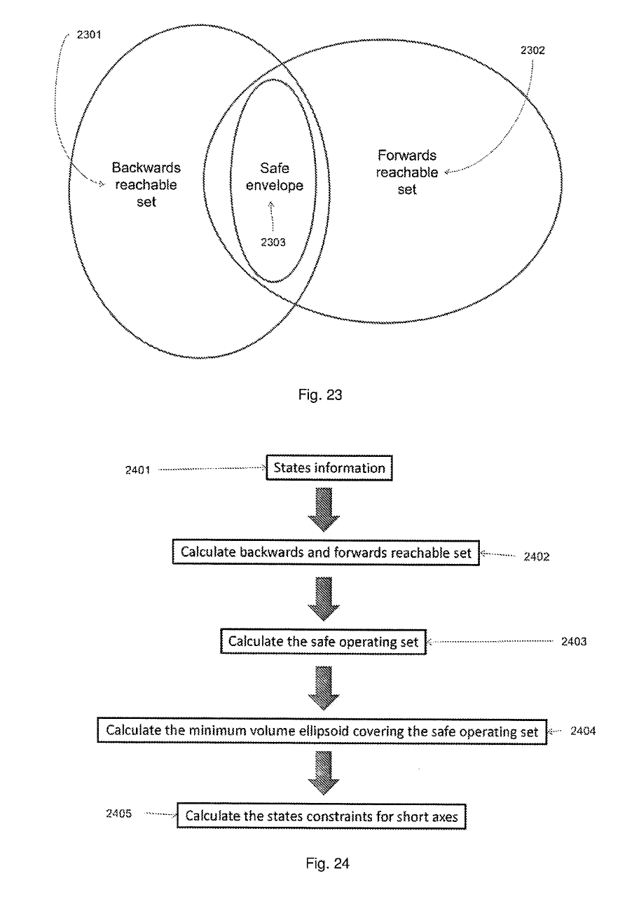

An example is illustrated in FIG. 23 on how to obtain a safe envelope 2303 (also called safe operating set or safe maneuvering set) based on agent dynamics. It is appreciated that in other examples, different ways may be utilized. An approach may be taken by defining a safe maneuvering (agent maneuvering) set as an intersection between forward and backwards reachable sets (2302 and 2301 respectively) for a given set of a-priori known safe states. Set refers to a collection of physical states. For a forwards reachable set 2302, initial conditions are specified and the set of all states that can be reached along agent trajectories that start in the initial set are determined. For a backwards reachable set 2301, a set of target states is defined, and a set of states from which agent trajectories start that can reach the target set are determined. A safe envelope (also called safe operating set) 2303 can be found by intersecting the forwards and backwards reachable sets (2302 and 2301 respectively). The need of intersecting both sets is illustrated with the following example.

Let an agent be an aircraft which enters a spin starting from a certain initial condition. The spin trajectory would then be included in the forwards reachable set 2302. If recovery to a safe flight condition from the spin is possible, the spin trajectory, or part of it, is also included in the backwards reachable set 2301. If recovery to a safe flight condition from the spin is not possible, then the spin trajectory, or part of it, is not included in the backwards reachable set 2301, and therefore, is not included in the safe envelope 2303.

As illustrated in FIG. 24, the following algorithm may be applied by the FDEA module 104 for determining states constraints (i.e. operating constraints).
At step 2401, the ATMS 1101 in FIG. 1 obtains the agent states information from different agents in the operating space 1105 in FIG. 1.

Using, for example, Multi-Parametric Toolbox (MPT) at step 2402, forwards and backwards reachable sets can be computed for linear and hybrid systems. MPT (version 3) is an open-source, MATLAB-based toolbox for parametric optimization, computational geometry and model predictive control. MPT (version 3) information is available at http://people.ee.ethz.ch/mpt/3/.

The safe operating set is generated as the intersection of the forwards and backwards reachable sets at step 2403.

Based on the safe operating set, a minimum volume ellipsoid can be calculated at step 2404 such that it covers the safe operating set.

Finally, the state constraints for short axes of the minimum volume ellipsoid can be calculated at step 2405.

Finding the minimum volume ellipsoid E_{S} that contains the safe operating set S={x₁, . . . , xₘ}ϵRₙ can be determined if ellipsoid covers S if and only if it covers its convex hull, therefore finding the minimum volume ellipsoid E_{S} that covers S is the same as finding the minimum volume ellipsoid containing a polyhedron. The minimum volume ellipsoid E_{S} that contains the safe operating set can be calculated using convex optimization, producing the short axes.

4.2.3 Model Predictive Control (MPC)

A path generator (i.e. the MPC module 106 in FIG. 1A of the ATMS 1101 in FIG. 1) may be configured to receive and process sub-region data or/and the boundaries information of the plurality of sub-regions generated by the FSRD module 102, together with, for example, waypoints of an agent's preplanned trajectory, safe distance between agents, maximum speed and maximum acceleration of the agent to generate a collision-free trajectory for the agent.

Model predictive control (MPC) carried out by the MPC module 106 is an advanced method of process control. Model predictive controllers rely on dynamic models of the process involved. In the present example, the MPC is formulated as an optimization problem (i.e. minimization of a cost function) subject to the system dynamics and constraints. Parameters to be employed in the cost may include length or time of an agent's route, distance between agents, energy level or fuel consumption, operating space regulations, number of maneuvers, load factors, etc. It allows a current time slot to be optimized, while keeping future time slots accounted for in the optimization process, which is achieved by optimizing a finite time-horizon (i.e. a future time interval), but only implementing the current time slot. Therefore, MPC has the ability to anticipate future events and can take control actions accordingly. MPC is optimal and dynamic in the sense of allowing to incorporate different constraints in real-time.

SAME (as described in section 4.2.2 under Full Dynamics Envelope Analysis (FDEA)) may be put into the MPC framework in which operating constraints will be time-varying during real time optimization process. The operating constraints may prevent an agent from engaging into a potentially hazardous phenomenon such as maneuvers beyond the agent's capabilities. These kinds of operating constraints are not fixed. They are dependent on agent's states and formation states. Thus, utilizing SAME in the MPC framework results in an adaptive MPC scheme. The safe operating set on which the time-varying states constraints (i.e. operating constraints) are based can be calculated in real time by the MPC module 106. With reference to the example described with reference to FIG. 24, the safe maneuvering envelope and minimum volume ellipsoid covering the safe operating set are essentially calculated inside of each MPC optimization process. In order for the MPC module 106 to generate dynamically feasible trajectories while fully utilizing each agent's dynamical resources, FDEA performed by the FDEA module 104 can provide a multi-agent coordinate framework. Based on dynamical model of each agent, a full dynamical envelope can be calculated at each control sampling time to generate boundaries of a dynamical envelope for every possible agent system input.

Different MPC approaches can be used. As an example, one approach is formulated herein, however other MPC formulations are applicable.

It is first assumed that each agent is equipped with an autopilot system, capable of waypoint tracking. Consider a set of m decoupled agent dynamical systems, where the i-th agent dynamics is described by a discrete-time state equation

xₖ₊₁ⁱ=Aⁱxₖⁱ+Bⁱuₖⁱ (1)

yₖⁱ=Cⁱxₖⁱ (2)

where Aⁱ∈ [symbol] ^{6×6}, Bⁱ∈ [symbol] ^{6×3} and Cⁱ∈ [symbol] ^{6×6}. The states and inputs of the agent at time k are denoted by xₖⁱ∈ [symbol] ⁶ and uₖⁱ∈ [symbol] ³, respectively. In particular

uₖⁱ=[\ddot{x}_{end},ÿ_{end},\ddot{z}_{end}]^{T}

yₖⁱ=[y_{k,pos}ⁱ^{^{T}},y_{k,vel}ⁱ^{^{T}}]^{T}=[x,y,z,\ddot{x},ÿ,\ddot{z}]^{T}

xₖⁱ=[x_{k,pos}ⁱ^{^{T}},x_{k,vel}ⁱ^{^{T}}]^{T}

and x_{k,pos}ⁱ∈ [symbol] ³ is the vector of x, y, z coordinates and x_{k,vel}ⁱ∈ [symbol] ³ denotes a vector of states corresponding to x-, y- and z-axis velocity at time k. The subscript cmd means the current commanded position. Let [symbol] ₖⁱ∈ [symbol] ^{m}^{ⁱ}, [symbol] ₖⁱ∈ [symbol] ⁿ^{ⁱ} and [symbol] ₖⁱ∈ [symbol] ^{p}^{ⁱ} denote the set of feasible inputs, states and outputs of the i-th vehicle

uₖⁱ∈ [symbol] ⁱ,xₖⁱ∈ [symbol] ⁱ,yₖⁱ∈ [symbol] ⁱ,k≥0 (3)

Eq. (Error! Reference source not found.) may indicate the operating constraints on the speed and acceleration of the vehicle (examples of dynamic envelopes provided by the FDEA module 104) as follows:

y_{k,pos}ⁱ∈ [symbol] ₚₒₛ={z∈ [symbol] ³|yₚₒₛⁱ≤zᵢ≤y̅ₚₒₛⁱ}

y_{k,vel}ⁱ∈ [symbol] ᵥₑₗ={z∈ [symbol] ³|yᵥₑₗⁱ≤zᵢ≤y̅ᵥₑₗⁱ}

uₖⁱ∈ [symbol] _{acc}={z∈ [symbol] ³|uᵢ≤zᵢ≤ūⁱ}

The set of m constrained systems is referred to as the multi-agent system.

The following cost function at time step k may be considered:

$${J}_{k} = {\sum }_{i = 1}^{m} {\sum }_{t = 0}^{N - 1} ( ‖ {y}_{k + t \vert {k}_{pos}}^{i} - {y}_{{f}_{pos}}^{i} ‖ Q + {‖ {u}_{k + t \vert k}^{i} ‖}_{R} + F ( {x}_{k + N} ) )$$

where ∥y_{k+t|k}_{ₚₒₛ}ⁱ−y_{f}_{ₚₒₛ}ⁱ∥Q represents the cost term driving the i-th agent to its target position and F(x_{k+N}) defines the terminal cost term. In particular, ∥P∥_{T} denote a weighted norm. Typical choices for the norms are quadratic forms _{P}^{T}T_{P}. Therefore, for each agent, the MPC controller can be presented as:

uₖ[=uₖ¹^{^{T}}, . . . ,uₖ^{m}^{^{T}}]^{T}=argmin Jₖ

subject to several operating constraints such as system dynamics

x_{k+t+1|k}ⁱ=Aⁱx_{k+t|k}ⁱ+Bⁱu_{k+t|k}ⁱ,t≥0

y_{k+t|k}ⁱ=Cⁱx_{k+t|k}ⁱ,t≥0

x_{k|k}ⁱ=xₖⁱ

state and control operating constraints (example of dynamic envelope, structural envelope and environment envelope provided by the FDEA module 104)

x_{k+t|k}ⁱ∈ [symbol] ₜⁱ,u_{k+t|k}ⁱ∈ [symbol] ₜⁱ,t=0, . . . N

and interconnection operating constraints (example of formation envelope provided by the FDEA module 104) for every i-th agent and its neighboring agents

q^{i,j}(x_{k+t+1|k}ⁱ,u_{k+t+1|k}ⁱ,x_{k+t+1|k}^{j},u_{k+t+1|k}^{j})≤0,t≥0,i,j=1, . . . ,m

where the control sequence is given by Uₖⁱ=[u_{k|k}ⁱ;u_{k+1|k}ⁱ; . . . ; u_{k+N-1|k}ⁱ;]^{T} and the double indices (k+j|k) denote the prediction at time k of a value at time k+j. For inter-agent collision avoidance, interconnection constraints may be included which define non-convex requirements in the following way:

d_{safe}−∥y_{k,pos}ⁱ−y_{k,pos}^{j}∥≤0 (4)

where the parameter d_{safe} represents a lower bound on the norm of relative position between neighboring agents i and j. The subscript p denotes the type of norm which can be used in the optimization problem. For example, p=2 leads to a circular protection zone around the agent, whereas p=1 or ∞ leads to square protection zones around the agent. The parameter d_{safe} may be adjusted for different agents and operating space conditions.

Once that the inputs uₖⁱ for each particular agent (i=1, . . . , m) have been obtained from solving the optimization problem above, they can be introduced into the state equations (1) and (2) to generate a list of waypoints as well as the corresponding velocities to navigate between waypoints.

The exemplified MPC algorithm above that can be carried out by the MPC module 106 provides a list of waypoints for an agent to travel from an initial to a final point compatible with its own dynamics and without exceeding the aforementioned operating constraints. From this list of waypoints, trajectories (i.e. movement paths) can be generated for each of a plurality of agents. These trajectories can be broadcasted from the ATMS 1101 to a plurality of Ground Control Stations, to a plurality of relay stations, or uploaded to the plurality of agents' onboard computer directly.

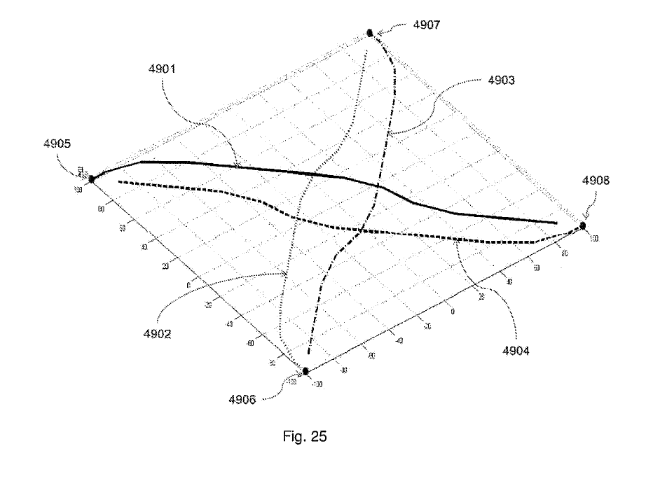

The MPC waypoint generation is illustrated in FIG. 25. It is first assumed that four agents 4901-4904 are initially following four trajectories joining points 4905 to 4908, 4908 to 4905, 4906 to 4907, and 4907 to 4906, respectively. These paths, when travelled at a same speed are likely to intersect with each other (i.e. the agents collide) in some central region. The initial and final points for the four agents are inputs for the MPC algorithm, which will generate intermediate waypoints for each particular agent 4901-4904. These waypoints de-conflict the collision area or in other words, avoid collision of the four agents 4901-4904.

The MPC algorithm can be used either in real-time or near real-time. The near real time accounts for reaction time required for a user to accept or neglect a suggested recommendation to re-route by the ATMS 1101 in FIG. 1.

The MPC algorithm may generate an optimized collision-free trajectory for the relevant agents which may then be used by the ATMS 1101 to generate a series of recommendations on the trajectory to take for each individual agent. Every agent's user may share with the ATMS 1101 whether its agent will adopt the suggested recommendation or not, such that operating constraints can be dynamically updated with the user-preferred intention. The ATMS 1101 recommendations should be as independent as possible of each other in the sense that the action taken by one agent should affect another agent action as little as possible and no conflict should arise if any of the agents choose not to take the provided recommendation. The ATMS 1101 may provide actions defined as a set of different path modifications rather than a single one. For example, a recommended navigation course modification should be given as a range of possible values and not as a unique one. By adopting such criteria in the ATMS 1101, it adds robustness and dynamism to the overall design.

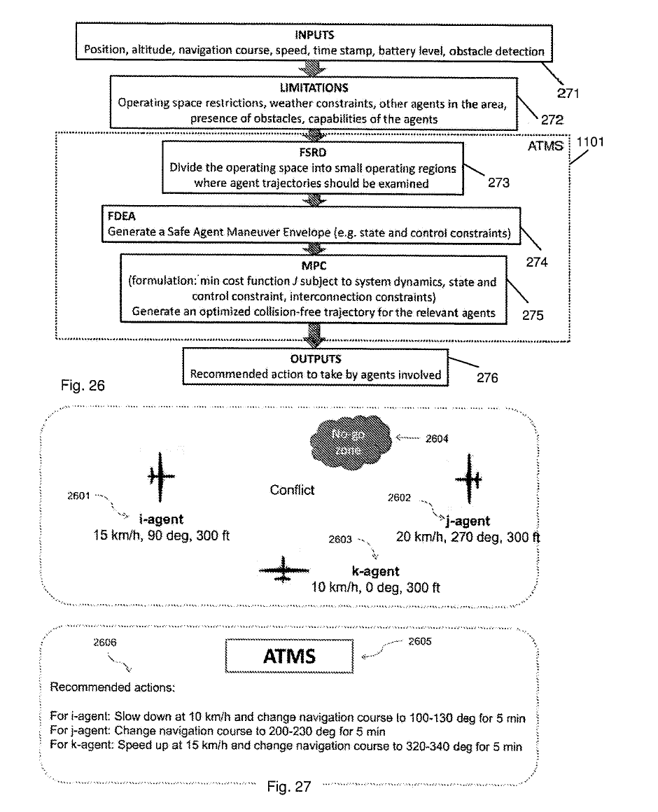

The re-planning method involving processing by the FSRD module 102 in FIG. 1A, the FDEA module 104 in FIG. 1A and the MPC module 106 in FIG. 1A can be summarized in FIG. 26.

The ATMS 1101 in FIG. 1 receives a series of inputs 271 (for example, position, altitude, navigation course, speed, time stamp, energy level, obstacle detection) as well as limitations 272 of the operating space 1105 in FIG. 1 (for example, operating space restrictions, weather constraints, other agents in the area, presence of obstacles, capabilities of the agents).

This information is processed in the ATMS 1101 in three steps namely 273, 274 and 275. The process combines three algorithms namely FSRD, FDEA and MPC. At step 273, the FSRD first divides the operating space 1105 into small operating regions (i.e. a plurality of sub-regions), where agent trajectories are to be examined to detect potential conflicts. These sub-regions together with the associated sub-region data are used by the FDEA algorithm to generate a SAME (i.e. operating constraints) at step 274. Finally, an optimization algorithm such as MPC minimizes a cost function subjected to the system dynamics, state and control constraints and interconnection constraints to determine optimal interference-free trajectories in the event of potential conflicts at step 275. In a final step 276, the ATMS 1101 outputs recommended actions (for example, recommended movement paths) to be taken to the agents involved through the communication interface 110 in FIG. 1A.

An example of three conflicting agents (i-agent 2601, j-agent 2602 and k-agent 2603) with their respective speed, navigation course and altitude (for example, 15 km/h, 90 degrees and 300 feet for i-agent; 20 km/h, 270 degrees and 300 feet for j-agent; and 10 km/h, 0 degrees and 300 feet for k-agent) in an operating space with a “no go” zone 2604 (for example, operating space restrictions, weather constraints or presence of obstacles) is illustrated in FIG. 27. After detecting the conflict, an ATMS 2605 will elaborate a recommended set of possible flight modification for each agent, i.e. 2606 (slow down at 10 km/h and change navigation course to 100-130 degrees for 5 minutes for i-agent; change navigation course to 200-230 degrees for 5 min for j-agent; and speed up to 15 km/h and change navigation course to 320-340 degrees for 5 min).

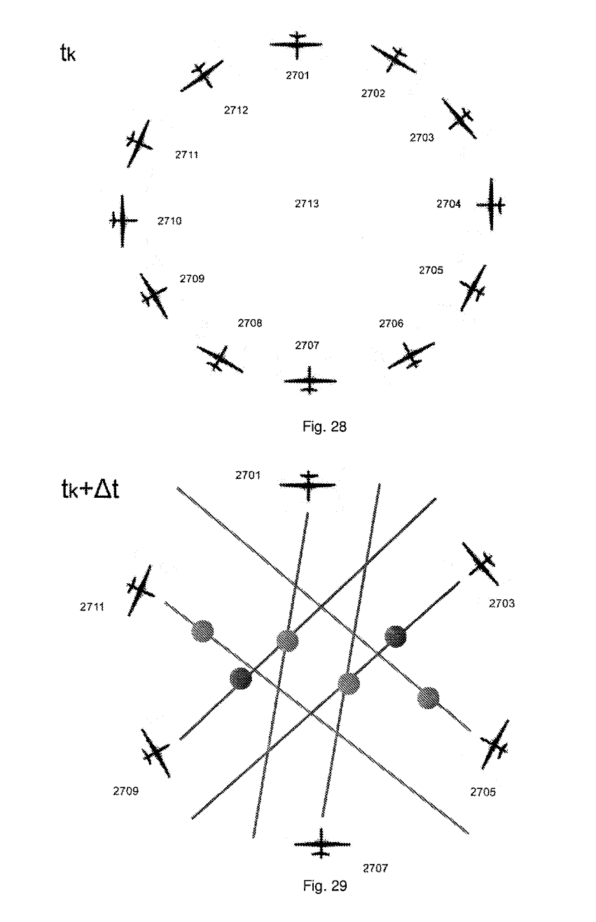

In another example in FIG. 28, there are twelve agents 2701-2712 assumed to initially fly with the same speed and at the same altitude, but with different courses. For instance, each agent follows a navigation course of 30 degrees more than its neighboring agent in an anticlockwise direction and 30 degrees less than its neighboring agent in a clockwise direction. As a reference, agent 2707 follows a navigation course of 0 degrees. Under these circumstances, a collision conflict is expected to happen at a central point 2713. In this case, an ATMS (For example, 2605 in FIG. 29) may recommend any six of the agents 2701-2712 to operate at a higher altitude, whereas the remaining six operate at a lower altitude. If any agent decides not to take the recommended suggestion, it will keep travelling at the same altitude, not conflicting with those which decided to follow the recommended suggestions.

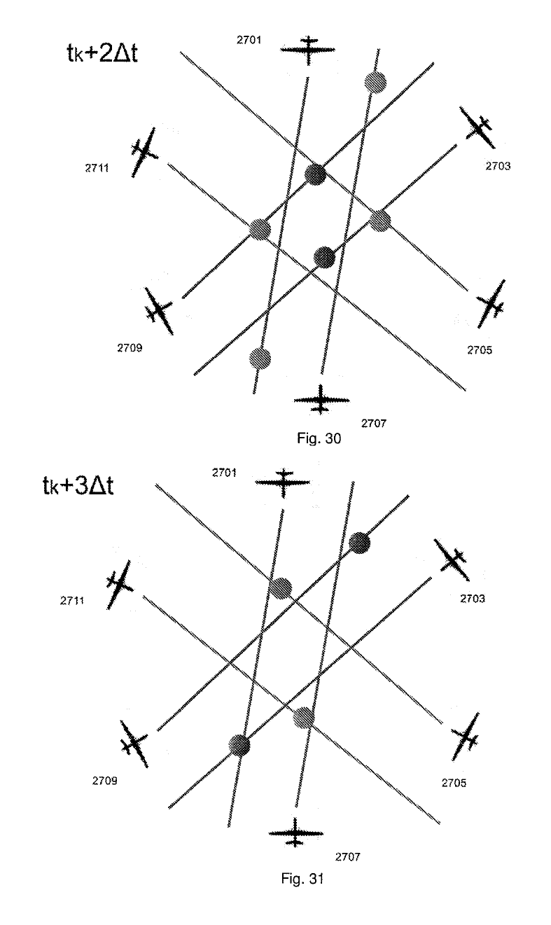

FIGS. 29, 30 and 31 illustrate six of the agents 2701, 2707, 2703, 2709, 2705 and 2711 in FIG. 28 which had decided to change altitude. FIG. 29 represents time interval Δt after the time interval tₖ of FIG. 28. FIG. 30 represents time interval 2Δt after the time interval tₖ of FIG. 28 and FIG. 30 represents time interval 3Δt after the time interval tₖ of FIG. 28. Navigation course is initially recommended by the ATMS (For example, 2605 in FIG. 27) to be modified to one side for some pairs of agents, including some speed modification recommendations. For example, agent 2701 and agent 2707 are suggested to move to their right and speed up, agent 2703 and agent 2709 are suggested to move to their right while keeping its initial speed, whereas agent 2705 and agent 2711 are suggested to move to their left and slow down. Thus, each agent will reach points represented in FIGS. 29 and 30 after some time interval Δt and 2Δt, respectively. After those time intervals, the conflict has been resolved and the agents may recover their initial speeds at time interval 3Δt as shown in FIG. 31.

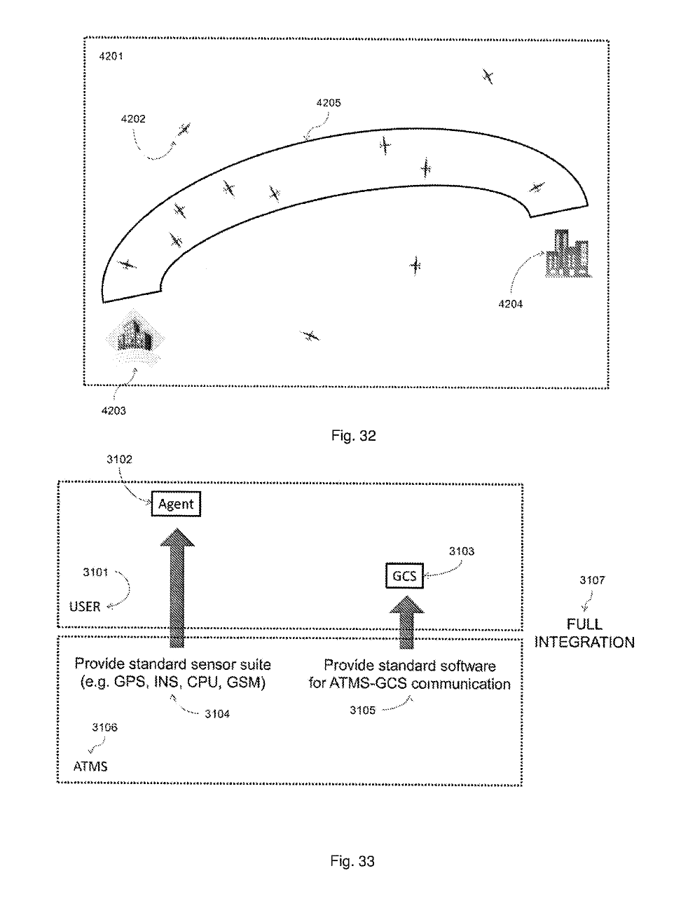

Under some circumstances, such as areas with well established traffic flows (for example, a multitude of agents frequently operating the same routes), the operating space in that region may be structured using corridors (for example, tubes in the operating space). Corridors are analogous to highways and may be permanent or temporary, designed in advance and dynamically adjusted based on the needs of the operating space. Corridors can be integrated with the earlier described system, and algorithms described herein are applicable. Particularly, MPC methods can be used to integrate agents arriving or departing the corridors with those agents already operating in the corridor. MPG methods can also be used to prevent agents from intersecting their trajectories with those of the corridors. An example is shown in FIG. 32, where an operating space 4201 with a plurality of agents (for example, 4202) is assumed to have two locations (for example, cities) 4203 and 4204, respectively, which generate a large traffic demand between them with agents operating similar routes. A corridor 4205 may subsequently be established to account for such traffic demand simplifying the overall architecture of the operating space 4201.

### 5. Applications

Applications for systems and methods described herein may include, without limitation, traffic management of multiple operating spaces (air, land, marine and underwater) and integration of different agents into such operating spaces. Agents may be manned or unmanned, at the commercial or consumer level, of different sizes and makes, using different software and, in general, as diverse as the units/parts may be available. In an example of air traffic management, agents may include UAVs (commercial and consumer users), commercial aviation or a mix of both. The advantage of the described systems and methods relies on continuous monitoring and generation of optimal collision-free trajectories in an unstructured operating space without any further limitation. Other approaches may include structuring of the operating space using similar concepts as there are in place for land vehicles, for example, defining paths similar to land roads. If such approach is taken, the system described herein is still applicable; however, such approach would constrain some free-of-obstacles three-dimensional operating spaces (for example, air and underwater) in the sense that not all of the potential operating space would be used. The earlier described algorithms have been shown to alleviate such constraint. Conservative restrictions on the use of the operating space would also imply longer travelled paths since it would lose part of its optimality, which would be translated in less range and endurance for the agents.

Regulatory authorities may take advantage of such system to enable an optimized use of the different operating spaces. Although the described system does not enforce its suggestions, such a regulatory authority may enforce the necessary actions to ensure a safe operation of the operating space via the described system. For example, some recommended trajectories may be enforced by the relevant authority when necessary.

FIG. 33 illustrates a way of easily integrating components of a system described in the present disclosure. It includes a user 3101 with its respective agent 3102 and associated GCS 3103. In an example, standard software 3104 and hardware 3105 may be distributed by an ATMS 3106. For example, a standard sensor suite including GPS, INS, CPU and GSM chip may be provided to be integrated with the agent; whereas standard software for ATMS-GCS communication may be provided to be integrated into the GCS 3103. Existing technologies allow the development of the mentioned software and hardware units whereas potential users already make use of a plurality of agents and GCS. By enabling this system, a quick and easy full integration 3107 can be achieved.

### 6. Advantages

More information on examples and advantages of the present disclosure is as follows.

Centralization

An ATMS described with reference to FIG. 1 (for example, at least 1101 of FIG. 1) is capable of enhancing a centralized system (for example, 1000 in FIG. 1) which ensures the global efficiency of the network of coordinated agents by optimally defining individual actions to be taken. Decentralized approaches and agent to agent conflict resolution do not provide the mentioned global optimization. Regulatory authorities may take advantage of such centralization. Such a centralized system may also be used to authenticate and verify the agents within the network. The ATMS is aware of agents operating in an operating space and, therefore, it can distinguish between cooperative and non-cooperative agents (rogue agents, agents failure and the like). Decentralized approaches and agent to agent conflict resolution cannot provide such authentication and verification.

Viability

The ATMS is inexpensive as the ATMS does not require a strong investment in infrastructures and/or systems given that it is based on currently existing systems and technologies.

Users Integration

The ATMS is user friendly due to its plug-and-play design. Software and hardware such as easy-to-develop sensors, communications systems, protocols, datasheets and software interfaces can be easily standardized and integrated into the agents and their respective GCS to provide an effective way to implement the present described system. The ATMS takes advantage of widely spread and accepted technologies to ease and empower users integration into the system (for example, personal computers, tablets or mobile devices via mobile applications to be used as GCS, and GSM networks used for communication with the ATMS). The ATMS may share information on the operating space (for example, operating space constraints, weather information, other agents in the area, obstacles, congestions, terrain and man-made objects, emergency gathering areas, charging stations, trajectory information and the like) with the agents connected to the ATMS to provide agents with a full situation awareness. Such situation awareness would not be possible without the presence of the ATMS system and its communication network.

Security

The ATMS is protected against failures, for instance, through duplication (i.e. redundancy) or back-up on another server, but not limited to them. Security layers can be added such that relevant information is only shared with the respective user, providing privacy to every user throughout the network and protecting confidential trajectories. The ATMS is able to record operating space's events and agent's trajectories and operations, which may be used for analysis and research purposes.

Safety

The ATMS is able to effectively manage the operating space and the agents wherein under all visibility conditions, including persistent communication, navigation, and surveillance. The ATMS and the disclosed planning algorithms provide safe operations. If obstacles not identified by the ATMS system are present, sensors on-board the cooperative agents may locate such obstacles for immediate collision-avoidance and report to the ATMS to take corrective actions for the full network.

The ATMS can provide trajectory guidance to non-autonomous agents in the operating space. This accounts for assistance on agent failure cases. The ATMS can support an agent to find an appropriate and safe spot (for example, landing spot in case of airborne agents) in case of on-board or external emergency by defining such areas and providing collision-free trajectories towards them. The ATMS is able to communicate with all agents and users as well as to monitor all at once to provide them with emergency gathering areas such that, under special circumstances, all the agents in a particular region can be suggested to gather at the aforementioned areas. The ATMS can suggest recommendations for each particular agent on how to modify the agent's current trajectory to reach the gathering area in a cooperatively way with respect to the rest of the agents. In an example of airborne agents, the emergency gathering areas may be emergency landing areas and the special circumstances may be “all-landing at once” scenarios.

By enabling scenarios as the one described above, the ATMS will ensure that rogue agents can be identified and appropriate action be taken if the need arises. After special situations where agents may have travelled to emergency gathering areas, the present described system is able to re-configure trajectories and enable normal operating conditions.

Constraints Integration

Based on the distributed meteorological sensors and the information shared by cooperative agents, the ATMS is able to real-time access and process data about weather conditions and forecast. The ATMS is able to evaluate the agents resistance to different weather conditions by initially acquiring the agents resistance information from the agents users via datasheets. Therefore, the ATMS is able to plan trajectories avoiding severe weather conditions (as defined by each particular agent), which are shared with the agent user for trajectory modification.

The ATMS is able to dynamically create and adjust geo-fencing areas which will need to be avoided due to multiple limitations such as operating space restrictions, weather constraints, congestions, presence of obstacles and non-cooperative agents, terrain and man-made objects and the like. By combining ground and agents detection capabilities with limitations such as operating space restrictions, weather constraints, congestions, presence of obstacles and non-cooperative agents, terrain and man-made objects and the like; the present described system can reconfigure some of the variables in the involved regions (for example, agents separation minima may be increased in wind conditions) to enable a safe and optimal operation of the agents wherein.

Planning Algorithms and Minimizing Computational Load

Based on combination of a priori knowledge of the agent's user-preferred intentions, continuous agent monitoring (for example, via ATMS, relay stations, GCS or agents themselves) and knowledge of the agent's performance characteristics, the ATMS is able to predict trajectories for some defined distance and/or within a time horizon. Based on the prediction of agents' trajectories, the present described system can predict congestions and enable safe separation at the initial planning. Proper initial planning allows an optimal use of the operating space and decreases the computational load required to resolve future conflicts by initially avoiding the conflicts (i.e. less use of FSRD, FDEA and MPC algorithms by predictive initial planning).

Based on the predictive capabilities mentioned above and the generation of dynamic envelopes, the present described system is able to predict potential conflicts such as collisions between agents and other obstacles or agents separation minima violated. Planning algorithms account for different factors and dynamic constraints including agents entering or leaving the network, performance capabilities of each agent, operating space restrictions, weather conditions, congestions and the like.

The ATMS is flexible and dynamic, allowing accommodating short notice limitations and constraints. The dynamic constraints in the described algorithms allows for the system to self-adjust in degrading operating conditions. Planning algorithms are able to accept requested trajectories provided by the agents' users. The algorithms are efficient. The algorithms exploit the maximum capabilities of the agents, their environment and the operating space by eliminating approaches that are too conservative (for example, road-like scenarios), which allow these algorithms to handle a larger number of agents than current approaches (for example, current commercial aviation traffic management).

The FSRD algorithm allows to greatly decrease the complexity of solving the different MPC control problems by constraining the use of MPC to small networks with constrained space or regions with multiple agents where a higher collision likelihood exists. Therefore, the FSRD algorithm allows to greatly decrease the system overall computational load to enable real-time applications. The FSRD algorithm provides a smart based-on-demand planning system.

The FDEA algorithm allows the MPC algorithm to provide feasible recommendations by avoiding loss of control and hazardous situations. The FDEA algorithm allows to exploit the maximum capabilities of the agents by incorporating information on the agents performance characteristics into the planned algorithms. The FDEA algorithm allows to safely operate a multitude of agents with different performance characteristics.

The MPC algorithm is able to generate conflict-free (including collision-free) trajectories for an agent to travel from an initial to a final point compatible with its own dynamics and without exceeding the aforementioned constraints. The MPC algorithm is able to generate trajectories based on arrival and departure locations and, thus, the new agent trajectories tend to maintain the initial ones. This mechanism avoids large deviations from the predicted trajectories, which helps simplifying and stabilizing the full operating space. The MPC algorithm is optimal (i.e. it minimizes a cost function). The MPC algorithm provides global optimality while maintaining individual agent level efficiencies.

The MPC algorithm guarantees that a nominal separation between agents is satisfied by imposing such separation minima as constraints. The MPC algorithm is able to provide sequencing and spacing in tight and constrained operating spaces. The combination of FSRD, FDEA and MPC algorithms allows an automated management of the operating space in real-time.

The algorithms provide users with a series recommendation allowing users to make the final decisions. Users may request the ATMS to operate their agents. The ATMS recommendations are as independent as possible for each agent in relation to the rest of the agents, in the sense that the action taken by one agent should affect another agent action as little as possible and no conflict should arise if any of the agents choose not to take the provided recommendation. The ATMS provide actions defined as a set of different path modifications rather than a single one; for example, a recommended navigation course modification is given as a range of possible values and not as a unique one. By adopting such criteria in the ATMS, it adds robustness and dynamism to the overall design.

Continuous Monitoring

The present described system (for example, 1000 in FIG. 1) enables persistent and redundant real-time continuous monitoring of the agents in the operating space through bi-directional information transfer between the agents in the network and the ATMS (for example, using relay stations, GCS or agents themselves). Continuous agent monitoring allows identifying those agents deviating from their respective nominal trajectories and subsequently define actions to be taken. Continuous agent monitoring enables agents separation monitoring. Continuous agent monitoring may be combined with detection capabilities of the cooperative agents in the network to sense, detect and track previously unknown objects in the operating space.

Heterogeneity

The present described system (for example, 1000 in FIG. 1) allows the integration of heterogeneous agents, including manned or unmanned, at the commercial or consumer level, of different sizes and makes, using different software and, in general, as diverse as the units/parts may be available. The system allows any platform to be plugged in to the network. The system is a platform agnostic system in the sense that it does not require specific information of the kind of agent operating in the area (only very general information is required such as agent's position, altitude, navigation course or velocity). The ATMS can provide trajectory guidance to non-autonomous agents in the operating space.

Automation

The present described system (for example, 1000 in FIG. 1) is a fully automated system, which significantly reduces the work load of human operators in similar systems. Such work load reduction allows human operators to focus on higher end tasks as well as increasing the operational capability of the operating space (normally limited by human operators' capabilities). A single automated ATMS approach can be taken, which would eliminate the need of interchanging data between different ATMS. Nevertheless, the disclosed system can be easily extended to any number of ATMS.

Applicability

The present described system (for example, 1000 in FIG. 1) allows the integration of commercial and consumer users and agents into the same operating space. The system can be easily applicable to create a safe and optimized environment where unmanned and piloted systems can coexist. The continuous monitoring and generation of optimal collision-free trajectories allows the disclosed method to be applicable in an unstructured operating space without any further limitation. Other approaches may have included structuring the operating space using similar concepts as for land vehicles (i.e. corridors). If such approach is taken, the system described herein is still applicable; however, such approach would constraint the free-of-obstacles three-dimensional operating space in the sense that not all of it would be used. Conservative restrictions on the use of the operating space would also imply longer travelled paths since it would lose part of its optimality, which would be translated in less range and endurance for the agents. Therefore, the system provides an optimization of spaces, allowing for optimal range and autonomy for the agents.

The system is also applicable to structured operating spaces (for example, use of corridors). Applicable operating spaces include air, land, water, underwater or space, but not limited to them. The system is scalable, i.e. able to change in size and/or scale, to accommodate a plurality of agents and account for multiple regions and/or scenarios.

While the above detailed description has described novel features as applied to various embodiments, it will be understood that various omissions, substitutions, and changes in the form and details of the illustrated devices or algorithms can be made without departing from the scope of the invention. As will be recognized, certain embodiments of the inventions described herein can be embodied within a form that does not provide all of the features and benefits set forth herein, as some features can be used or practiced separately from others. The scope of certain inventions disclosed herein is indicated by the appended claims rather than by the foregoing description. All changes which come within the meaning and range of equivalency of the claims are to be embraced within their scope. Accordingly, the present disclosure is not intended to be limited by the recitation of the above embodiments.

1. An apparatus for controlling agent movement in an operating space, the apparatus comprising:
a processor;
a communication interface configured for communicating with a plurality of ground control stations and/or a plurality of agents in the operating space to allow the apparatus to receive information about the operating space, each of the plurality of ground control stations being configured for controlling and monitoring a group of the plurality of agents;
a storage device for storing one or more routines which, when executed under control of the processor, control the apparatus to:
process information about the operating space received by the communication interface to predict one or more interfering condition in the operating space;
divide the operating space into a plurality of sub-regions based on the predicted one or more interfering condition;
define operating constraints for each of the one or more of the plurality of agents in each sub-region having the predicted one or more interfering condition; and
generate a movement path in the respective sub-region having the predicted one or more interfering condition for each of the one or more of the plurality of agents in each sub-region having the predicted one or more interfering condition based on the defined operating constraints so as to avoid the predicted one or more interfering condition,
wherein the communication interface is configured for transmitting data of the movement path to the plurality of ground control stations and/or the one or more of the plurality of agents in each sub-region having the predicted one or more interfering condition.

2. The apparatus as claimed in claim 1, wherein the apparatus is configured, under control of the processor to:
process information about the operating space received by the communication interface from a plurality of relay stations in the operating space to predict the one or more interfering condition in each of the plurality of sub-regions.

3. The apparatus as claimed in claim 2, wherein:
each of the plurality of relay stations is associated with a sub-space in the operating space and is configured for relaying information about the sub-space to the communication interface from one or more of the plurality of agents present in the sub-space or from one or more of the plurality of ground control stations or configured for obtaining information about the sub-space from one or more of the plurality of agents present in the sub-space or from one or more of the plurality of ground control stations, and
each of the plurality of ground control stations is configured for controlling and monitoring a group of the plurality of agents and each of the plurality of ground control stations is configured for obtaining information about the operating space from the respective group of the plurality of agents.

4. The apparatus as claimed in claim 1, wherein the communication interface is configured for communicating with a network enabled device other than the plurality of ground control stations and the plurality of agents for obtaining information of the operating space to be processed by the processor to predict the one or more interfering condition in each of the plurality of sub-regions.

5. The apparatus as claimed in claim 1, wherein the one or more routines are executed continuously in real time during operation of the apparatus to process the information about the operating space to predict the one or more interfering condition and generate the movement path in the respective sub-region having the predicted one or more interfering condition for each of the one or more of the plurality of agents in each sub-region having the predicted one or more interfering condition to avoid the predicted one or more interfering condition.

6. The apparatus as claimed in claim 1, wherein each of the plurality of agents is an unmanned aerial vehicle.

7. The apparatus as claimed in claim 1, wherein process information about the operating space received by the communication interface to predict one or more interfering condition in the operating space includes:
determine a zone surrounding each of the plurality of agents in the operating space;
determine whether the zones surrounding each of the plurality of agents intersect with each other; and
predict presence of the one or more interfering condition if the zones intersect with each other.

8. The apparatus as claimed in claim 1, wherein process information about the operating space received by the communication interface to predict one or more interfering condition in the operating space includes:
determine a no-access zone in the operating space based on the information about the operating space received by the communication interface;
determine one or more reference points approximating a contour of the no-access zone;
determine whether a zone surrounding each of the plurality of agents intersects with the contour of the no-access zone;
and
predict presence of the one or more interfering condition if the zone surrounding the plurality of agents intersects with the contour of the no-access zone.

9. The apparatus as claimed in claim 1, wherein process information about the operating space received by the communication interface to predict one or more interfering condition in the operating space includes:
determine a value indicative of closest distance between two agents of the plurality of agents along pre-determined movement paths of the two agents in the operating space; and
predict presence of the one or more interfering condition by comparing the value with a threshold value.

10. The apparatus as claimed in claim 1, wherein the apparatus is configured, under control of the processor to:
determine a monitoring zone in the operating space based on the information about the operating space received by the communication interface; and
monitor the monitoring zone to determine whether the monitoring zone has to be changed into an interfering condition.

11. The apparatus as claimed in claim 1, wherein divide the operating space into a plurality of sub-regions based on the predicted one or more interfering condition includes:
divide the operating space into a plurality of cells, wherein each of the plurality of cells corresponds with a corresponding agent in the plurality of agents; and
merge a first set of cells to form a sub-region of the plurality of sub-regions if the predicted one or more interfering condition affect the corresponding agents in the first set of cells.

12. The apparatus as claimed in claim 10, wherein divide the operating space into a plurality of sub-regions based on the predicted one or more interfering condition further includes:
merge a second set of cells to form a sub-region of the plurality of sub-regions if none of the predicted one or more interfering condition affect the corresponding agents in the second set of cells.

13. The apparatus as claimed in claim 1, wherein the apparatus is configured, under control of the processor to:
analyze dynamics of each of the one or more of the plurality of agents in the sub-region having the predicted one or more interfering condition; and
define the operating constraints for each of the one or more of the plurality of agents in each sub-region having the predicted one or more interfering condition based on the analyzed dynamics.

14. The apparatus as claimed in claim 1, wherein the apparatus is configured, under control of the processor to:
analyze structure of each of the one or more of the plurality of agents in each sub-region having the predicted one or more interfering condition; and
define the operating constraints for each of the one or more of the plurality of agents in each sub-region having the predicted one or more interfering condition based on the analyzed structure.

15. The apparatus as claimed in claim 1, wherein the apparatus is configured, under control of the processor to:
analyze movement formation that each of the one or more of the plurality of agents is configured to form in each sub-region having the predicted one or more interfering condition; and
define the operating constraints for each of the one or more of the plurality of agents in each sub-region having the predicted one or more interfering condition based on the analyzed movement formation.

16. The apparatus as claimed in claim 1, wherein the apparatus is configured, under control of the processor to:
analyze environmental conditions surrounding each of the one or more of the plurality of agents in each sub-region having the predicted one or more interfering condition; and
define the operating constraints for each of the one or more of the plurality of agents in each sub-region having the predicted one or more interfering condition based on the analyzed environmental conditions.

17. The apparatus as claimed in claim 1, wherein generate the movement path in the respective sub-region for each of the one or more of the plurality of agents in each sub-region having the predicted one or more interfering condition includes generate a plurality of waypoints or a plurality of operating trajectories in the respective sub-region for the respective one of the plurality of agents in each sub-region having the predicted one or more interfering condition based on the defined operating constraints.

18. The apparatus as claimed in claim 1, wherein generate the movement path in the respective sub-region for each of the one or more of the plurality of agents in each sub-region having the predicted one or more interfering condition includes formulate the movement path as a cost minimization function subject to the defined operating constraints.

19. The apparatus as claimed in claim 1, wherein the storage device stores a database of emergency gathering areas for one or more of the plurality of agents to navigate to one or more of the emergency gathering areas.

20. The apparatus as claimed in claim 1, wherein the storage device stores a database of power supply charging stations for the one or more of the plurality of agents to navigate to one or more of the power supply charging stations.

21. The apparatus as claimed in claim 1, wherein the apparatus is configured, under control of the processor to:
divide the operating space into a plurality of sub-areas, wherein each of the plurality of sub-areas is assigned an indicator to indicate a degree of interference and the degree of interference depends on number of the plurality of agents in the respective sub-area.

22. The apparatus as claimed in claim 21, wherein the apparatus is configured, under control of the processor to:
generate an initial movement path for each of the plurality of agents in the operating space before departure of the respective agent based on the assigned indicators of the plurality of sub-areas so as to avoid the predicted one or more interfering condition.

23. The apparatus as claimed in claim 1, wherein the communication interface is configured to transmit one or more of the following to the plurality of ground control stations and/or the plurality of agents:
operating space restrictions to the plurality of agents in the operating space;
weather update and forecast in the operating space;
location of one or more agents adjacent to one of the plurality of agents;
location of obstructing terrain that contributes to the one or more interfering condition; and
location of man-made object that contributes to the one or more interfering condition.

24. A method for controlling agent movement in an operating space, the method comprising:
communicating with a plurality of ground control stations and/or a plurality of agents in the operating space to receive information about the operating space;
processing information about the operating space to predict one or more interfering condition in the operating space;
dividing the operating space into a plurality of sub-regions based on the predicted one or more interfering condition;
defining operating constraints for each of the one or more of the plurality of agents in each sub-region having the predicted one or more interfering condition; and
generating a movement path in the respective sub-region having the predicted one or more interfering condition for each of the one or more of the plurality of agents in each sub-region having the predicted one or more interfering condition based on the defined operating constraints so as to avoid the predicted one or more interfering condition; and
transmitting data of the movement path to the plurality of ground control stations and/or the one or more of plurality of agents in each sub-region having the predicted one or more interfering condition.

25. A system for controlling agent movement in the operating space, the system comprising:
a plurality of agents;
a plurality of ground control stations, wherein each of the plurality of ground control stations is configured for controlling and monitoring a group of the plurality of agents and each of the plurality of ground control stations is configured for obtaining information about the operating space from the respective group of the plurality of agents;
and
the apparatus of claim 1.

26. The system as claimed in claim 25, the system comprising:
a plurality of relay stations, wherein each of the plurality of relay stations is associated with a sub-space in the operating space and is configured for relaying information about the sub-space to the communication interface from one or more of the plurality of agents present in the sub-space or from one or more of the plurality of ground control stations or configured for obtaining information about the sub-space from one or more of the plurality of agents present in the sub-space or from one or more of the plurality of ground control stations.
